(19) United States
(12) Patent Application Publication
(10) Pub. No.: US 2025/0338090 A1
(43) Pub. Date: Oct. 30, 2025

(54) New Service and Service Operations for 5MBS

(71) Applicant: Telefonaktiebolaget LM Ericsson (publ), Stockholm (SE)

(72) Inventors: Yunjie Lu, Shanghai (CN); Juying Gan, Shanghai (CN); Jie Ling, Shanghai (CN)

(21) Appl. No.: 18/579,525

(22) PCT Filed: Jul. 11, 2022
(86) PCT No.: PCT/CN2022/104853

§ 371 Date: Jan. 16, 2024

(30) Foreign Application Priority Data
Jul. 16, 2021 (WO) PCT/CN2021/106832

(51) Int. Cl. H04W 4/06; H04W 12/75; H04W 12/76; H04W 76/30

(52) U.S. Cl. CPC H04W 4/06; H04W 12/75; H04W 12/76; H04W 76/30

(57) ABSTRACT

The present disclosure generally relates to wireless or mobile communication. More particularly, the present disclosure relates to a method for providing Multicast and Broadcast Service (MBS). The present disclosure also relates to apparatus and computer program product adapted for the same purpose. According to one embodiment of the present disclosure, a method for providing Multicast and Broadcast Service (MBS) is characterized in comprising: at a Multicast and Broadcast-Session Management Function (MB-SMF) node, generating a request for managing MBS broadcast contexts at one or more Access and Mobility Management Function (AMF) nodes involved in an MBS session; and sending the request from the MB-SMF node to the AMF nodes.

### TECHNICAL FIELD

The present disclosure generally relates to wireless or mobile communication. More particularly, the present disclosure relates to a method for providing Multicast and Broadcast Service (MBS). The present disclosure also relates to apparatus and computer program product adapted for the same purpose.

### BACKGROUND

### Re 5 MBS Architecture and Overall Description

TS 23.247 v1.0.0 reads as,
“4.1 Principles of multicast and broadcast communication
. . .
Multicast and Broadcast Service (MBS) is a point-to-multipoint service in which data is transmitted from a single source entity to multiple recipients.
There are two types of MBS session:
   Broadcast session;
   Multicast session.
5.1 General architecture
FIGS. 5.1-1 depicts the 5G MBS reference architecture. Service-based interfaces are used within the Control Plane.
Multicast-broadcast service for roaming is not supported in this release.
Interaction between multicast-broadcast service and support of deployments topologies with specific SMF Service Areas is not specified in this release.”

FIG. 1 depicts an 5G MBS system architecture. The MBSF is optional and may be collocated with the NEF or AF/AS, and the MBSTF is an optional network function. The existing service based interfaces of Nnrf, Nudm, and Nsmf are enhanced to support 5G MBS. The existing service based interfaces of Npcf and Nnef are enhanced to support 5G MBS; their usage depends on deployment. xMB-C/MB2-C and xMB-U/MB2-U are intended for legacy AS. A 5G MBS AF uses either Nmbsf or Nnef to interact with the MBSF.

FIG. 2 depicts the 5G MBS system architecture using the reference point representation showing how various network functions interact with each other. The existing reference points of N1, N2, N11 are enhanced to support 5G MBS.

### Re Multicast Communication Procedures: MBS Session Activate/Deactivate/Update

MBS session activation and deactivation

### General

MBS Session activation procedure is for multicast only. MBS Session activation procedure is triggered by MB-SMF, when it receives the notification from MB-UPF for the downlink MBS DL data, or when it receives the request directly from AF or via NEF. The MBS Session activation procedure is used for activating the resources for MBS data at NG-RAN node. The multicast session state transits from inactive to active after MBS Session activation procedure, see clause 4.3.

MBS Session deactivation procedure is for multicast only. MBS Session deactivation procedure is triggered by MB-SMF, when it receives the notification from MB-UPF in the case of no downlink data to be transmitted, or when it receives the request directly from AF or via NEF. The MBS Session deactivation procedure is used for deactivating the resources for MBS data at NG-RAN node. The multicast session state transits from active to inactive after MBS Session deactivation procedure, see clause 4.3.

### MBS Session Activation Procedure

The following can trigger the MBS session activation procedure:
AF requests MB-SMF to activate the MBS session;
MB-UPF receives the multicast data and notifies MB-SMF.

FIG. 3 depicts MBS session activation procedure. In FIG. 3:
1. The procedure may be triggered by the following events:
   When MB-UPF receives downlink data for a MBS session, MB-UPF sends MB-N4 Notification (N4 Session ID) to the MB-SMF for activating the MBS session.
   AF sends MBS Activation request (TMGI) to the MB-SMF directly or via NEF.
2. MB-SMF sends Session activation notification (TMGI) to SMF(s).

Based on the received TMGI, SMF finds the list of UEs that joined the MBS session identified by the TMGI. If SMF determines the user plane of the associated PDU session(s) of the UE(s) with respect to TMGI are activated already, steps 3-9 will be skipped for those UE.
3. SMF sends MBS_Session_Notification Request to AMF, with including (UE list, TMGI).

After receiving the request, for each UE in the list, the AMF determines CM state of the UE: see steps 4-7.
4. [Optional] If the UE involved in the MBS Session is in CM-CONNECTED state, the AMF responds the list of the UE involved in the MBS Session and in CM-CONNECTED state, using MBS_Session_Notification Response (UE list). Step 5-6 will not be executed for that UEs in the list.
5. [Optional] If AMF determines that there are any UEs in CM-IDLE state and involved in the MBS Session, and AMF figures out the paging area considering all the UE(s), which need be paged. The AMF sends a paging request message to the NG-RAN node(s) belonging to this Paging Area with the TMGI as the identifier to be paged if the related NG-RAN node(s) support the MBS session.

The details of the paging are specified by the RAN WGs.
6. The UE in IDLE state sends Service Request message to AMF, see clause 4.2.3 of TS 23.502.
7. After receiving the Service Request sent by the UE, the AMF responds to MB-SMF with MBS_Session_Notification Response (UE ID) message.
8. After receiving MBS_Session_Notification Response message, SMF determines the related UE is in CM-Connected State and sends Namf_Communication_N1N2MessageTransfer (N2 SM message (MBS Session identifier, associated QoS profiles) to AMF for the UE which is identified in step 3.
9. AMF sends N2 request message (N2 SM message (MBS Session identifier, associated QoS profiles) to the RAN node.
10. If the shared tunnel has not been established before, the shared tunnel is established at this step, as steps 7a to 7e defined in clause 7.2.1.3. In addition, NG-RAN responses to SMF, as steps 9 to 12 defined in clause 7.2.1.3. The NG-RAN configures UE with RRC messages if needed.
11.MB-SMF sends Session Activation (TMGI) to the AMF.

The messages in step 10 and 11 is MBS-specific messages and it is possible that the AMF(s) in step 10 are not associate to any UEs involved in the MBS Session.
12. AMF sends NGAP activation message (TMGI) to the RAN nodes.

### MBS Session Deactivation Procedure

FIG. 4 depicts MBS session deactivation procedure. In FIG. 4:
1. The procedure may be triggered by the following events:
   When MB-UPF detects there is no data receives for the MBS Session, MB-UPF sends MB-N4 Notification (N4 Session ID) to the MB-SMF for deactivating the MBS session.
   AF sends MBS Deactivation request (TMGI) to the MB-SMF directly or via NEF.
2. The MB-SMF sends MBS Session deactivation request (TMGI) to the SMFs.

For 5GC Individual MBS traffic delivery, the SMFs trigger the removal of the unicast QoS flows at NG-RAN node, which is used for the transmission of MBS session identified by the TMGI.
3. The MB-SMF sends MBS Session deactivation Request (TMGI) to the AMFs.
4. The AMF sends NGAP deactivation request message (TMGI) to the RAN nodes.
5. NG-RAN sets the MBS session state with respect to TMGI to inactive. In this procedure, the NG-RAN will not release the MBS session context, and MB-N3 tunnel for the MBS session.

Whether the NG-RAN removes the MBS Session Context or mark it as inactive requires RAN collaboration.
6. NG-RAN acknowledges the NGAP deactivation Response message.
7. The AMF invokes MBS Session deactivation Response to acknowledge the service for MB-SMF.

### Multicast Session Update Procedure

Multicast session update procedure is invoked by the AF to update the ARP for an ongoing multicast session. For the interaction between AF and MB-SMF, see clause 7.1.1.5 and 7.1.1.6.

FIG. 5 depicts Multicast session update procedure. In FIG. 5:
1. This procedure is triggered by the MB-SMF receiving the updated policy for MBS, see clauses 7.1.1.5 and 7.1.1.6.
2. The MB-SMF generates the QoS profile for the multicast, and sends MBS Session update Request (N2 SM message (TMGI, QoS profiles for multicast)) to the AMF(s).
3. The involved AMF forwards the N2 SM information received from MB-SMF to the RAN nodes via NGAP Session update Request (N2 SM message (TMGI, QoS profiles for multicast)) message.

Whether it is the AMF or the MB-SMF that stores RAN ID for the interaction with RAN in step 3 needs to align with clause 7.2.1.
4. NG-RAN updates the MBS session context, and if only the ARP of QoS parameters is updated, NG-RAN node also updates the QoS parameters of the associating PDU Sessions.

Updating the associated PDU Session's QoS based on the update of MBS Session QoS by NG-RAN requires RAN WGs collaboration.
5. The NG-RAN acknowledges NGAP Session update Request by sending an NGAP Session update Response message to the AMF.
6. The AMF sends MBS Session update Response to the MB-SMF.
7. MB-SMF sends Session update Request (TMGI, QOS profiles for multicast) to SMF.
8. SMF determines the UE list regarding the TMGI included in the message. If the QoS parameters other than ARP needs to be updated, SMF triggers PDU Session Modification procedure for each UE as defined in TS 23.502.

### MB-SMF Service and Service Operations as Specified

Per TS 23.247 v1.0.0, the following MB-SMF service and service operations are specified:

### “MB-SMF Services

### General

The following table illustrates the MB-SMF Services for MBS.

TABLE 9.1.1-1
NF services provided by MB-SMF

| | Service | Operation | Example |
|---|---|---|---|
| Service Name | Operations | Semantics | Consumer (s) |
| Nmbsmf_{—} | Request | Request/Response | NEF, MBSF, AF |
| TMGI | Release | Request/Response | NEF, MBSF, AF |
| Nmbsmf_{—} | Request | Request/Response | AMF, SMF |
| Reception | Release | Request/Response | AMF, SMF |
| Nmbsmf_{—} | Request | Request/Response | SMF |
| Information | Notify | Subscribe/Notify | SMF |
| | Subscribe | | SMF |
| | Unsubscribe | | SMF |
| Nmbsmf_{—} | Create | Request/Response | MBSF, NEF, |
| MBSSession | | | AF |
| | Update | Request/Response | MBSF, NEF, |
| | | | AF |
| | Release | Request/Response | MBSF, NEF, |
| | | | AF |

### Nmbsmf_TMGI Service

### General

Service description: NF Service Consumer can use this service to request the allocation of TMGIs and release allocated TMGIs.

### Nmbsmf_TMGI_Request Service Operation

Service operation name: Nmbsmf_TMGI_Request.
Description: NF Service Consumer can use this service to request the allocation of TMGIs.
Inputs, Required: Number of TMGIs
Inputs, Optional: None
Outputs, Required: TMGIs, Expiry Time
Outputs, Optional: None.

### Nmbsmf_TMGI_Release Service Operation

Service operation name: Nmbsmf_TMGI_Release.
Description: NF Service Consumer can use this service to request the release of TMGIs.
Inputs, Required: TMGIs
Inputs, Optional: FFS.
Outputs, Required: Success or not.
Outputs, Optional: None.

### Nmbsmf_Reception Service

### General

Service description: NF Service Consumer can use this service to request the reception of MBS data or to terminate the reception of MBS data.

### Nmbsmf Reception Request Service Operation

Service operation name: Nmbsmf_Reception_Request.
Description: NF Service Consumer can use this service to request the reception of data of a multicast session
Inputs, Required: Multicast Session ID, if consumer is AMF: AMF ID and RAN node ID, if consumer is SMF: SMF ID
Inputs, Optional: Area Session ID, Unicast GTP Tunnel ID
Outputs, Required: Success or not
Outputs, Optional: Multicast GTP Tunnel ID

### Nmbsmf Reception Release Service Operation

Service operation name: Nmbsmf_Reception_Release.
Description: NF Service Consumer can use this service to request the termination of MBS data transmission
Inputs, Required: Multicast Session ID, if consumer is AMF: AMF ID and RAN node ID, if consumer is SMF: SMF ID.
Inputs, Optional: Area Session ID
Outputs, Required: Success or not
Outputs, Optional: None.

### Nmbsmf_Information Service

### General

Service description: NF Service Consumer can use this service to request or subscribe information about an MBS session.

The following are the key functionalities of this NF service:
Allow consumer NFs to request for information (e.g. QoS information) of MBS Session(s);
Allow consumer NFs to subscribe and unsubscribe for an Event ID on MBS Session(s); and
Notifying events on the MBS Session to the subscribed NFs.

The following events can be subscribed by a consumer NF:
QOS flow change: The event notification is sent when Qos flows within an MBS session change, e.g. adding/removing QoS flow(s).
MBS Session status (activated, deactivated).
MBS Session establishment and/or MBS Session release.

### Nmbsmf Information Request Service Operation

Service operation name: Nmbsmf_Information_Request.
Description: Service Consumer NF can use this service to request information (e.g. QoS information) for an multicast session.
Inputs, Required: Multicast Session ID.
Inputs, Optional: Area Session ID.
Outputs, Required: QoS information for multicast session.
Outputs, Optional: None.

### Nmbsmf Information Notify Service Operation

Service operation name: Nmbsmf_Information_Notify
Description: Provided by the MB-SMF to notify NF consumers of the subscribed events.
Inputs, Required: Event ID, Notification Correlation Information.
Inputs, Optional: Event information.
Outputs, Required: Operation execution result indication.
Outputs, Optional: None.

### Nmbsmf Information Subscribe Service Operation

Service operation name: Nmbsmf_Information_Subscribe.
Description: Service Consumer NF subscribes to or modifies a subscription to notification of events about an multicast session.
Inputs, Required: Multicast Session ID, Event ID.
Inputs, Optional: Area Session ID, Subscription Correlation ID (in the case of modification of the event subscription).
Outputs, Required: When the subscription is accepted: Subscription Correlation ID.
Outputs, Optional: None

### Nmbsmf Information Unsubscribe Service Operation

Service operation name: Nmbsmf_Information_Unsubscribe
Description: Used by the consumer NF to explicitly unsubscribe to the notification of events about the multicast session.
Inputs, Required: Subscription Correlation ID.
Inputs, Optional: None.
Outputs, Required: Operation execution result indication.
Outputs, Optional: None.

### Nmbsmf_MBSSession Service

### General

Service description: This service operates on the multicast and broadcast sessions. The following are the key functionalities of this NF service:
   (between MBSF/NEF and MB-SMF) Create/Modification/Activation/Deactivation/Release of multicast sessions;
   (between MBSF/NEF and MB-SMF) Create/Modification/Start/Stop/Release of broadcast sessions;

### Nmbsmf MBSSession Create Service Operation

Service operation name: Nmbsmf_MBSession_Create.
Description: Create a new multicast session or broadcast session during MBS session configuration.
Input, Required: MBS Session ID (source specific multicast address or TMGI) or TMGI request
Input, Optional: DNN, S-NSSAI, MBS service area, MBS activation time, MBS termination time, service description, QoS flow information, Input Transport Address Request, session activity status (active/inactive).
Output, Required: Result Indication.
Output, Optional: TMGI, Cause, MB-UPF tunnel info.

### Nmbsmf MBSSession Update Service Operation

Service operation name: Nmbsmf_MBSession_Update.
Description: Update the established multicast session or broadcast session, e.g. QoS update.
Input, Required: MBS Session ID.
Input, Optional: QOS flow information, MBS service area, session activity status (active/inactive).
Output, Required: Result Indication.
Output, Optional: Cause.

### Nmbsmf MBSSession Release Service Operation

Service operation name: Nmbsmf_MBSession_Release.
Description: Release the multicast session or broadcast session.
Input, Required: MBS Session ID.
Input, Optional: None.
Output, Required: Result Indication.
Output, Optional: Cause.

### SUMMARY

For broadcast communication, what SBI service in AMF is used is not yet specified. For multicast communication, SBI services for some procedures (e.g. MBS Session Activate/Deactivate/Update) are not specified. Furthermore, For multicast communication, the MB-SMF services Nmbsmf_Reception and Nmbsmf_Information are not optimized.

In some solutions of the present disclosure, for broadcast communication, it defines new AMF service and service operations, allowing NF consumer (e.g., MB-SMF) to manage MBS Broadcasting Contexts at AMF for NG-RAN broadcasting MBS content in specified broadcast service areas. The examples of the new AMF service and service operations include but are not limited to:
Namf_MBSBroadcast_ContextCreate
Namf_MBSBroadcast_ContextUpdate
Namf_MBSBroadcast_ContextDelete
Namf_MBSBroadcast_ContextStatusNotify

In some solutions of the present disclosure, for multicast communications, it defines new MB-SMF service operations, and optimizes the MB-SMF services and service operations as follows:

It provides MB Session Context resource at MB-SMF to handle service operations from NF consumers (e.g., AMF/SMF), and support subscribe/notify communication to allow NF consumer to get informed on the status update of the context. Thus, information flows from different directions (DL/UL) are handled independently by different service operations. Service procedure is simplified and more efficient because NF consumer/producer invokes service operation only when needed (i.e. to deliver the information to the peer).

In some solutions of the present disclosure, NF consumers can update Context to provide the RAN information (e.g. tunnel info.) by using Nmbsmf_MBSSession_UpdateContext service further described as below, which can replace the “Nmbsmf_Reception” service in TS 23.247 v1.0.0.

In some solutions of the present disclosure, NF consumers can subscribe to and get notified of the Context Status change (e.g. QoS updated, status change like activation/deactivation, etc.) by using Nmbsmf_MBSSession_ContextStatusSubscribe and Nmbsmf_MBSSession_ContextStatusNotify services further described as below, which can replace the “Nmbsmf_Information” service in TS 23.247 v1.0.0.

In some solutions of the present disclosure, AMF service and service operations are newly defined to allow NF consumer (e.g. MB-SMF) to manage MBS Broadcasting Contexts at AMF for NG-RAN broadcasting the MBS data in specified broadcast service areas. The examples of the newly defined AMF service and service operations includes but are not limited to:
Namf_MBSBroadcast_ContextCreate
Namf_MBSBroadcast_ContextUpdate
Namf_MBSBroadcast_ContextDelete
Namf_MBSBroadcast_ContextStatusNotify

The above examples will be further described as below.

In some solutions of the present disclosure, MB-SMF service operations are modified to optimize the handling of MBS Session. These optimized operations define MB Session Context resource at MB-SMF with both request/response and subscribe/notify service operations, i.e. information flows from different directions (DL/UL) are handled independently and NF consumer/producer invoke corresponding service operations only when needed.

New service operation Nmbsmf_MBSSession_UpdateContext, which will be described as below, can replace the “Nmbsmf_Reception” service in TS 23.247 v1.0.0.

Moreover, New service operation such as Nmbsmf_MBSSession_ContextStatusSubscribe & Nmbsmf_MBSSession_ContextStatusNotify, which will be described as below, can replace the “Nmbsmf_Information” service in TS 23.247 v1.0.

### BRIEF DESCRIPTION OF THE DRAWINGS

The foregoing and other objects, features, and advantages of the disclosure would be apparent from the following more particular description of preferred embodiments as illustrated in the accompanying drawings in which:

FIG. 1 depicts an 5G MBS system architecture.

FIG. 2 depicts the 5G MBS system architecture using the reference point representation showing how various network functions interact with each other.

FIG. 3 depicts MBS session activation procedure.

FIG. 4 depicts MBS session deactivation procedure.

FIG. 5 depicts Multicast session update procedure.

FIG. 6 depicts an overview of new/updated MB-SMF service operations for multicast and broadcast communication, and new AMF service for broadcast communication.

FIG. 7 depicts a flowchart illustrating a method for providing Multicast and Broadcast Service (MBS) according to one embodiment of the present disclosure.

FIG. 8 illustrates a processor-based implementation of a network node which may be used for implementing the above-described embodiments.

FIG. 9 depicts a flowchart illustrating a method for providing Multicast and Broadcast Service (MBS) according to another embodiment of the present disclosure.

FIG. 10 illustrates a processor-based implementation of a network node which may be used for implementing the above-described embodiments.

FIG. 11 depicts a flowchart illustrating a method for providing Multicast and Broadcast Service (MBS) according to another embodiment of the present disclosure.

FIG. 12 depicts a flowchart illustrating a method for providing Multicast and Broadcast Service (MBS) according to another embodiment of the present disclosure.

FIG. 13 depicts a flowchart illustrating a method for providing Multicast and Broadcast Service (MBS) according to another embodiment of the present disclosure.

FIG. 14 illustrates a processor-based implementation of a network node which may be used for implementing the above-described embodiments.

FIG. 15 depicts a flowchart illustrating a method for providing Multicast and Broadcast Service (MBS) according to another embodiment of the present disclosure.

FIG. 16 depicts a flowchart illustrating a method for providing Multicast and Broadcast Service (MBS) according to another embodiment of the present disclosure.

FIG. 17 depicts a flowchart illustrating a method for providing Multicast and Broadcast Service (MBS) according to another embodiment of the present disclosure.

FIG. 18 illustrates a processor-based implementation of a network node which may be used for implementing the above-described embodiments.

FIG. 19 depicts a flowchart illustrating a method for providing Multicast and Broadcast Service (MBS) according to another embodiment of the present disclosure.

FIG. 20 depicts a flowchart illustrating a method for providing Multicast and Broadcast Service (MBS) according to another embodiment of the present disclosure.

FIG. 21 illustrates a processor-based implementation of a network node which may be used for implementing the above-described embodiments.

FIG. 22 depicts a flowchart illustrating a method for providing Multicast and Broadcast Service (MBS) according to another embodiment of the present disclosure.

FIG. 23 illustrates a processor-based implementation of a network node which may be used for implementing the above-described embodiments.

FIG. 24 depicts a flowchart illustrating a method for providing Multicast and Broadcast Service (MBS) according to another embodiment of the present disclosure.

FIG. 25 illustrates a processor-based implementation of a network node which may be used for implementing the above-described embodiments.

### DETAILED DESCRIPTION

Before describing in detail exemplary embodiments, it is noted that components have been represented where appropriate by conventional symbols in the drawings, showing only those specific details that are pertinent to understanding the embodiments so as not to obscure the disclosure with details that will be readily apparent to those of ordinary skill in the art having the benefit of the description. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the term “coupled,” “connected,” and the like, may be used herein to indicate a connection, although not necessarily directly, and may include wired and/or wireless connections.

### Overview

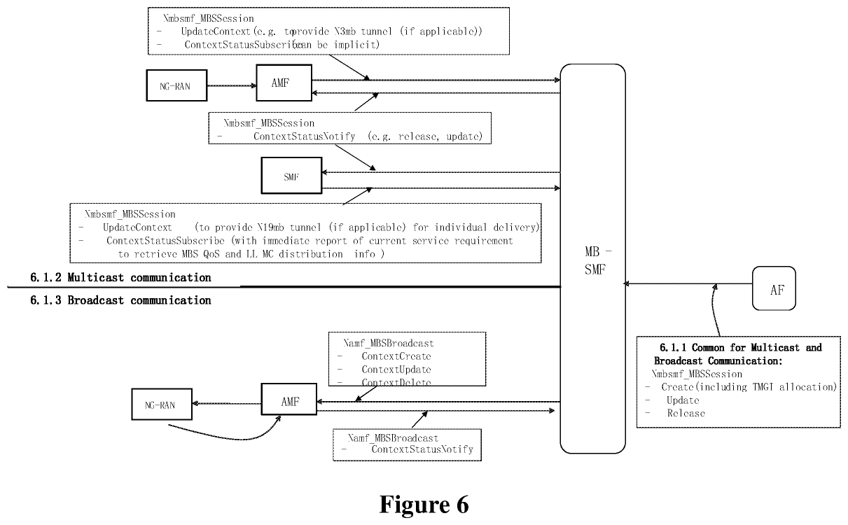

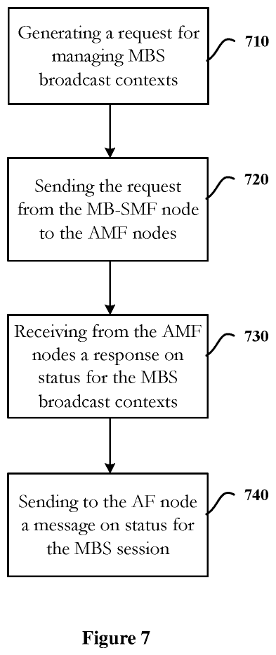

FIG. 6 depicts an overview of new/updated MB-SMF service operations for multicast and broadcast communication, and new AMF service for broadcast communication.

### 6.1.1 Common for Multicast and Broadcast Communication: Updated MB-SMF Service Operations

From the AF to MB-SMF (note that between AF and MB-SMF, NEF and/or MBSF may be involved), the MB-SMF service operations are updated as follows:
#1 Nmbsmf_MBSSession_Create is used to:
allocate TMGI only (new), or
allocate TMGI and provide service requirement, or
provide service requirement.

Note that by using Nmbsmf_MBSSession_Create operation, Nmbsmf_TMGI_Request service operation currently specified in TS 23.247 v1.0.0 is not needed.
#2 Nmbsmf_MBSSession_Update is used to:
provide service requirement (new), or
update service requirement, and/or MBS service area, or
remove service requirement (new).
#3 Nmbsmf_MBSSession_Release is used to:
remove the service requirement and de-allocate the TMGI (new).

Note that by using Nmbsmf_MBSSession_Update operation, Nmbsmf_TMGI_Release service operation currently specified in TS 23.247 v1.0.0 is not needed.
#4 MB-SMF notifies the AMF of the MBS Session status change in MB-SMF, e.g. MBS Session Update/Release.

For details, see:
Appendix 1: “S2-210xxxx_23247 Update [9.1] MB-SMF services and Resolving ENs”; and
Appendix 2: “Update [7.1] Common Procedure with modified MB-SMF service operation”.
   6.1.2 For Multicast communication: new MB-SMF service operations

### Between AMF and MB-SMF:

AMF subscribes to context status change of MB-SMF when there is NG-RAN involved in the MBS Session.

If NG-RAN provides its UP (User Plane) information for N3mb (i.e. interface between NG-RAN and MB-UPF), AMF invokes new service operation Nmbsmf_MBSSession_UpdateContext to MB-SMF to transfer the NG-RAN's UP information to MB-SMF. At the same time, AMF implicitly subscribes to the context status change.

If NG-RAN does not provide its UP information (implying that multicast transport over N3mb is applied), the AMF will explicitly subscribe to the MB-SMF of the context status change by invoking Nmbsmf_MBSSession_ContextStatusSubscribe.

### Between SMF and MB-SMF:

When the first UE joins, the SMF retrieves MBS session info (i.e. QoS info, Multicast distribution info) from MB-SMF by invoking Nmbsmf_MBSSession_ContextStatusSubscribe with immediate reporting of the current status.

When the last UE leaves, the SMF unsubscribes to context status change in MB-SMF.

When 5GC individual delivery is applied, and if unicast transport over N19mb is applied, then SMF will provide the UPF's UP information of N19mb to the MB-SMF in Nmbsmf_MBSSession_UpdateContext.

When an MBS Session in MB-SMF is changed, e.g. updated/released by the AF, the MB-SMF notifies the status change to AMF using new service operation Nmbsmf_MBSSession_ContextStatusNotify.

For details, see:
Appendix 1: “S2-210xxxx_23247 Update [9.1] MB-SMF services and Resolving ENs”; and
Appendix 3: “update to 23.247 v1.0.0 [7.2] modMB-SMF service”.
   6.1.3 For Broadcast communication: new AMF service

New AMF service Namf_MBSBroadcast is introduced with the following service operations:
Namf_MBBroadcast_ContextCreate: to create the broadcast Session towards the AMF
Namf_MBBroadcast_ContextUpdate: to update the broadcast Session towards the AMF
Namf_MBBroadcast_ContextRelease: to release the broadcast context towards the AMF
Namf_MBBroadcast_ContextStatusNotify: for AMF to notify MB-SMF of context status change, e.g. AMF notifies MB-SMF of the NG-RAN MBS UP information received from NG-RAN.

When the MBS Session is created by the AF, the MB-SMF creates resource in the AMF for broadcast communication using new service operation Namf_MBSBroadcast_ContextCreate.

When the MBS Session is updated by the AF, the MB-SMF determines
if any new AMF(s) are to be added, i.e. MB-SMF invokes Namf_MBSBroadcast_ContextCreate; and/or
if any existing AMF are to be released resource, i.e. MB-SMF invokes Namf_MBSBroadcast_ContextRelease; and/or
if existing AMF(s) are to be updated using Namf_MBSBroadcast_ContextUpdate.

When the MBS Session is released by the AF, the MB-SMF release resource in the AMF(s) for broadcast communication using new service operation Namf_MBSBroadcast_ContextRelease.

For details, see:
Appendix 4: “S2-210xxxx_23247new[9.3]_AMFservice” for new AMF service”; and
Appendix 5: “update to 23.247 v1.0.0 [7.3]modMB-SMF service”.

### Embodiments

### For Broadcast Communication

FIG. 7 depicts a flowchart illustrating a method for providing Multicast and Broadcast Service (MBS) according to one embodiment of the present disclosure.

As shown in FIG. 7, the flowchart comprises the following steps:

Step 710: a Multicast and Broadcast-Session Management Function (MB-SMF) node generates a request for managing MBS broadcast contexts at one or more Access and Mobility Management Function (AMF) nodes involved in an MBS session.

Optionally, at step 710, in response to an event that the MBS Session is created by an Application Function (AF) node, the MB-STF node generates a request for creating the MBS broadcast contexts as the request for managing MBS broadcast contexts. The request for creating the MBS broadcast contexts may include at least one of following items: Temporary Mobile Group Identifier (TMGI), MBS QoS profile, broadcast service area, and MBS IP multicast distribution.

Optionally, at step 710, in response to an event that the MBS Session is released by an Application Function (AF) node, the MB-SMF node generates a request for releasing the MBS broadcast contexts as the request for managing MBS broadcast contexts. The request for releasing the MBS broadcast contexts may include TMGI.

Optionally, at step 710, in response to an event that the MBS Session is updated by an Application Function (AF) node, if the MB-SMF node determines there is any new AMF node involved in the MBS session, it may generate a request for creating the MBS broadcast contexts at the new AMF node as the request for managing MBS broadcast contexts. The request for creating the MBS broadcast contexts may include at least one of following items: Temporary Mobile Group Identifier (TMGI), MBS QoS profile, broadcast service area, and MBS IP multicast distribution.

Optionally, at step 710, in response to an event that the MBS Session is updated by an Application Function (AF) node, if the MB-SMF node determines there is anyone of the AMF nodes which is not involved in the MBS session, it generates a request for releasing the MBS broadcast contexts at the AMF node not involved in the MBS session as the request for managing MBS broadcast contexts. The request for releasing the MBS broadcast contexts may include TMGI.

Optionally, at step 710, in response to an event that the MBS Session is updated by an Application Function (AF) node, the MB-SMF node may generate a request for updating the MBS broadcast contexts as the request for managing MBS broadcast contexts. The request for releasing the MBS broadcast contexts may include at least one of following items: TMGI, MBS QoS profile and broadcast service area.

Step 720: the MB-SMF node sends the request from the MB-SMF node to the AMF nodes.

Step 730: the MB-SMF node receives from the AMF nodes a response on status for the MBS broadcast contexts.

Optionally, the response on status for the MBS broadcast contexts may include TMGI or Radio Access Network (RAN) MBS UP information.

Step 740: the MB-SMF node sends to the AF node a message on status for the MBS session based on the response on status for the MBS broadcast contexts, which is received from the AMF nodes at step 730.

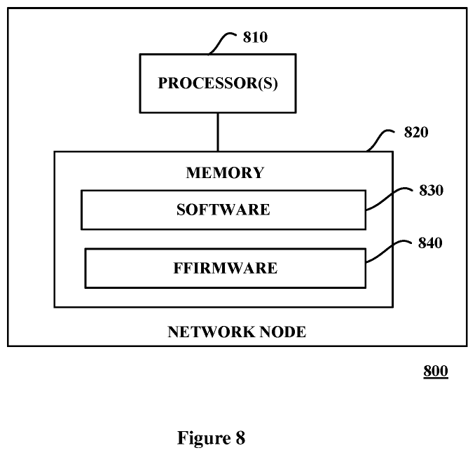

FIG. 8 illustrates a processor-based implementation of a network node which may be used for implementing the above-described embodiments. For example, the structures as illustrated in FIG. 8 may be used for implementing the concepts in the above-mentioned MB-SMF node.

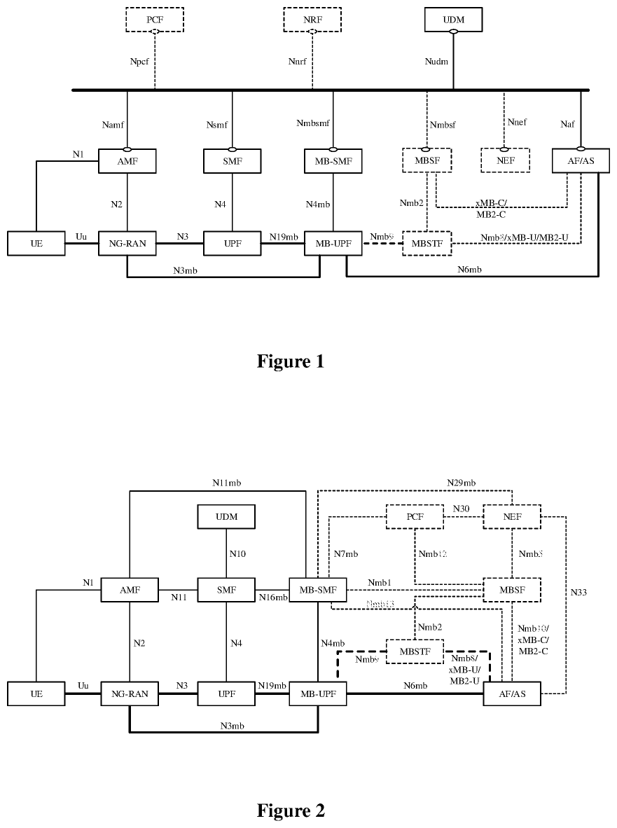

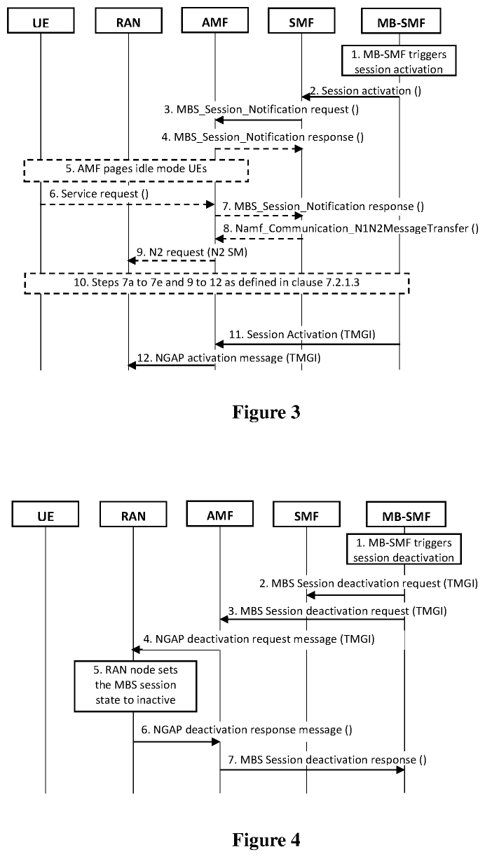

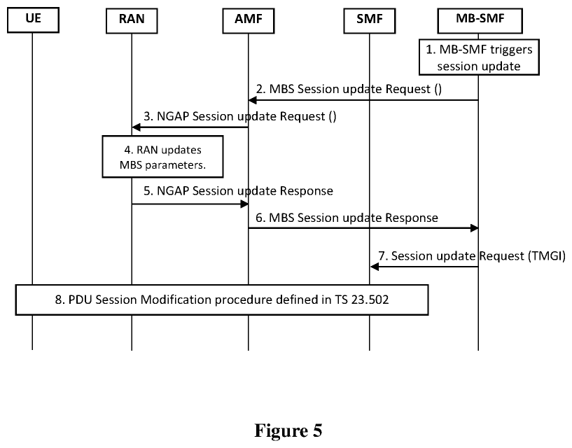

As illustrated, the node 800 may include one or more processors 810 and a memory 820 coupled to the processor(s) 810. By way of example, the processor(s) 810 and the memory 820 could be coupled by one or more internal bus systems of the node 800. The memory 820 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 820 may include software 830 and/or firmware 840. The memory 820 may include suitably configured program code to be executed by the processor(s) 810 so as to implement the above-described functionalities, such as explained in connection with FIGS. 1-7.

According to some embodiments, also a computer program may be provided for implementing functionalities of the node 800, e.g., in the form of a physical medium storing the program code and/or other data to be stored in the memory 820 or by making the program code available for download or by streaming.

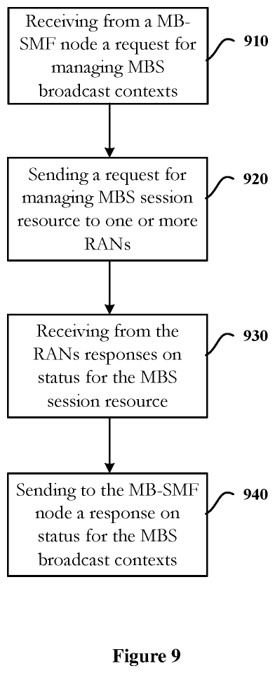

FIG. 9 depicts a flowchart illustrating a method for providing Multicast and Broadcast Service (MBS) according to another embodiment of the present disclosure.

As shown in FIG. 9, the flowchart comprises the following steps:

Step 910: an AMF node involved in an MBS session receives from a MB-SMF node a request for managing MBS broadcast contexts at the AMF node.

Step 920: the AMF node sends a request for managing MBS session resource to one or more Radio Access Networks (RANs).

Step 930: the AMF node receives from the RANs responses on status for the MBS session resource.

Optionally, each of the responses on status for the MBS session resource includes TMGI or Radio Access Network (RAN) MBS UP information from the respective RAN.

Step 940: the AMF node sends to the MB-SMF node a response on status for the MBS broadcast contexts based on the responses on status for the MBS session resource, which is received from the RANs at step 930.

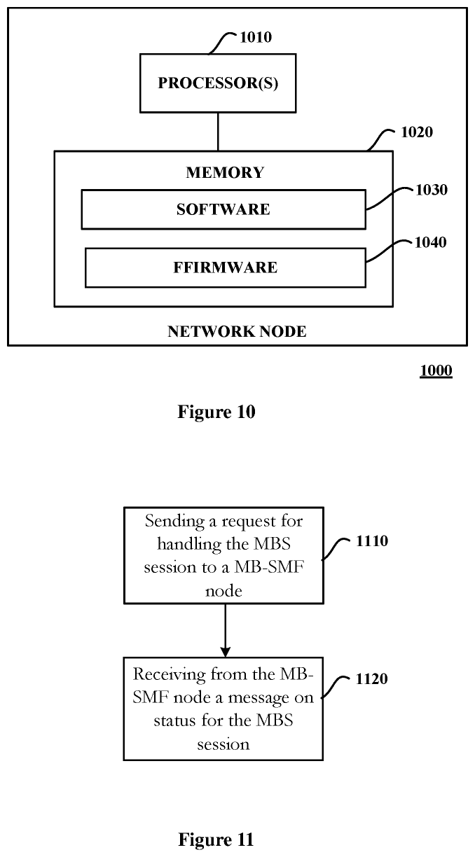

FIG. 10 illustrates a processor-based implementation of a network node which may be used for implementing the above-described embodiments. For example, the structures as illustrated in FIG. 10 may be used for implementing the concepts in the above-mentioned AMF node.

As illustrated, the node 1000 may include one or more processors 1010 and a memory 1020 coupled to the processor(s) 1010. By way of example, the processor(s) 1010 and the memory 1020 could be coupled by one or more internal bus systems of the node 1000. The memory 1020 may include a Read-Only-Memory (ROM), e.g., a flash ROM, a Random Access the memory 1020 may include software 1030 and/or firmware 1040. The memory 1020 may include suitably configured program code to be executed by the processor(s) 1010 so as to implement the above-described functionalities, such as explained in connection with FIGS. 1-6 and 9.

According to some embodiments, also a computer program may be provided for implementing functionalities of the node 1000, e.g., in the form of a physical medium storing the program code and/or other data to be stored in the memory 1020 or by making the program code available for download or by streaming.

Common for multicast and broadcast communication

FIG. 11 depicts a flowchart illustrating a method for providing Multicast and Broadcast Service (MBS) according to another embodiment of the present disclosure.

As shown in FIG. 11, the flowchart comprises the following steps:

Step 1110: in response to creation of an MBS session, an Application Function (AF) node sends a request for handling the MBS session to a MB-SMF node directly or indirectly, e.g., via NEF and/or MBSF. The request for handling the MBS session may be used for at least one of the following: 1) obtaining TMGI only; or 2) obtaining TMGI and providing service requirement; or 3) providing service requirement.

Step 1120: the AF node receives from the MB-SMF node a message on status for the MBS session.

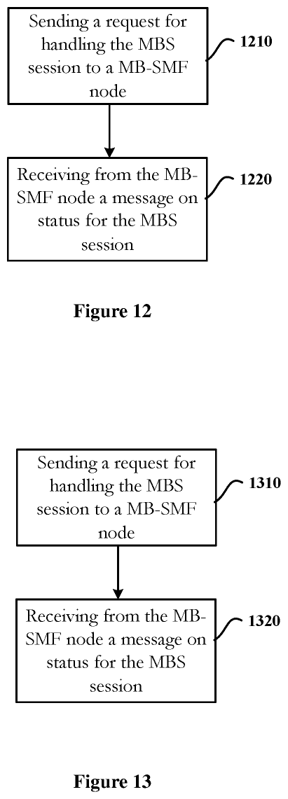

FIG. 12 depicts a flowchart illustrating a method for providing Multicast and Broadcast Service (MBS) according to another embodiment of the present disclosure.

As shown in FIG. 12, the flowchart comprises the following steps:

Step 1210: in response to updating of an MBS session, an Application Function (AF) node sends a request for handling the MBS session to a MB-SMF node directly or indirectly, e.g., via NEF and/or MBSF. The request for handling the MBS session may be used for at least one of the following: 1) providing service requirement; or 2) updating service requirement and/or MBS service area; or 3) removing service requirement.

Step 1220: the AF node receives from the MB-SMF node a message on status for the MBS session.

FIG. 13 depicts a flowchart illustrating a method for providing Multicast and Broadcast Service (MBS) according to another embodiment of the present disclosure.

As shown in FIG. 13, the flowchart comprises the following steps:

Step 1310: in response to release of an MBS session, an Application Function (AF) node sends a request for handling the MBS session to a MB-SMF node directly or indirectly, e.g., via NEF and/or MBSF. The request for handling the MBS session may be used for removing service requirement and de-allocating TMGI.

Step 1320: the AF node receives from the MB-SMF node a message on status for the MBS session.

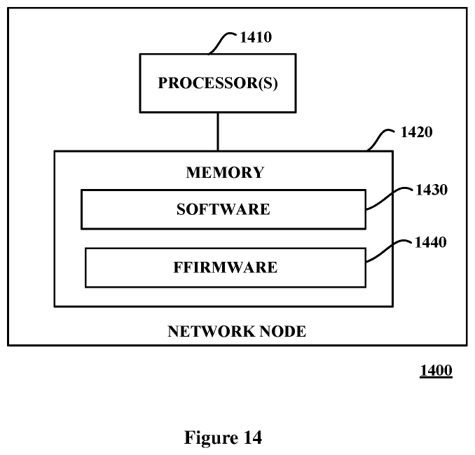

FIG. 14 illustrates a processor-based implementation of a network node which may be used for implementing the above-described embodiments. For example, the structures as illustrated in FIG. 14 may be used for implementing the concepts in the above-mentioned AF node.

As illustrated, the node 1400 may include one or more processors 1410 and a memory 1420 coupled to the processor(s) 1410. By way of example, the processor(s) 1410 and the memory 1420 could be coupled by one or more internal bus systems of the node 1400. The memory 1420 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1420 may include software 1430 and/or firmware 1440. The memory 1420 may include suitably configured program code to be executed by the processor(s) 1410 so as to implement the above-described functionalities, such as explained in connection with FIGS. 1-6 and 11-13.

According to some embodiments, also a computer program may be provided for implementing functionalities of the node 1400, e.g., in the form of a physical medium storing the program code and/or other data to be stored in the memory 1420 or by making the program code available for download or by streaming.

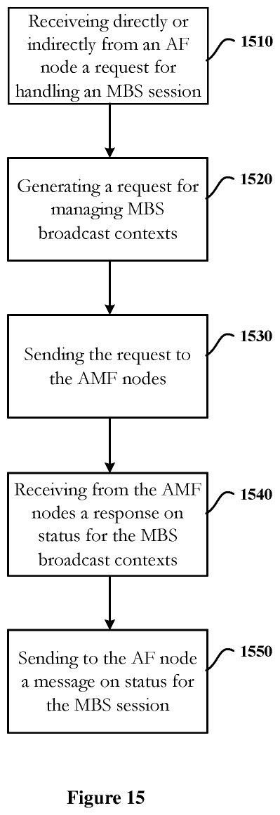

FIG. 15 depicts a flowchart illustrating a method for providing Multicast and Broadcast Service (MBS) according to another embodiment of the present disclosure.

As shown in FIG. 15, the flowchart comprises the following steps:

Step 1510: an MB-SMF node receives directly or indirectly from an AF node a request for handling an MBS session. The request for handling the MBS session is directed toward creation of the MBS session and used for at least one of the following: 1) obtaining TMGI only; or 2) obtaining TMGI and providing service requirement; or 3) providing service requirement.

Step 1520: the MB-SMF node generates a request for managing MBS broadcast contexts at one or more AMF nodes involved in the MBS session.

Step 1530. the MB-SMF node sends the request to the AMF nodes.

Step 1540: the MB-SMF node receives from the AMF nodes a response on status for the MBS broadcast contexts.

Step 1550: the MB-SMF node sends to the AF node a message on status for the MBS session.

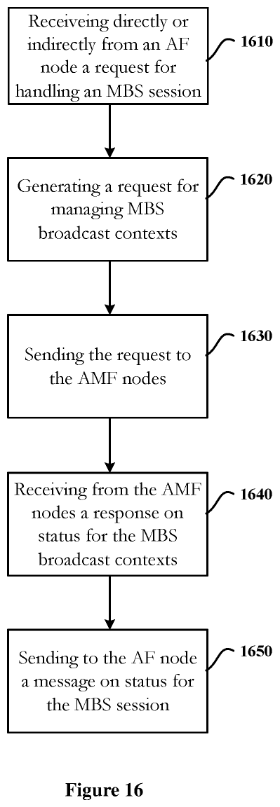

FIG. 16 depicts a flowchart illustrating a method for providing Multicast and Broadcast Service (MBS) according to another embodiment of the present disclosure.

As shown in FIG. 16, the flowchart comprises the following steps:

Step 1610: an MB-SMF node receives directly or indirectly from an AF node a request for handling an MBS session. The request for handling the MBS session is directed toward updating of the MBS session and may be used for at least one of the following: 1) providing service requirement; or 2) updating service requirement and/or MBS service area; or 3) removing service requirement.

Step 1620: the MB-SMF node generates a request for managing MBS broadcast contexts at one or more AMF nodes involved in the MBS session.

Step 1630: the MB-SMF node sends the request to the AMF nodes.

Step 1640: the MB-SMF node receives from the AMF nodes a response on status for the MBS broadcast contexts.

Step 1650: the MB-SMF node sends to the AF node a message on status for the MBS session.

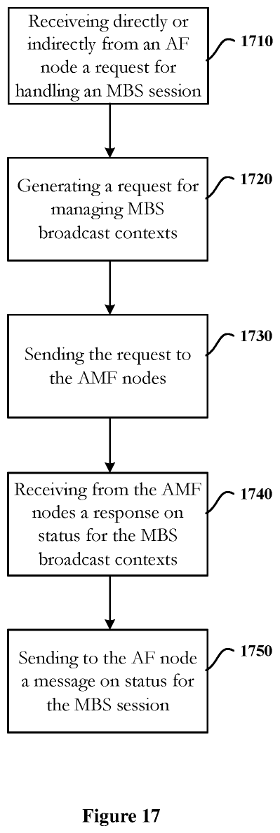

FIG. 17 depicts a flowchart illustrating a method for providing Multicast and Broadcast Service (MBS) according to another embodiment of the present disclosure.

As shown in FIG. 17, the flowchart comprises the following steps:

Step 1710: an MB-SMF node receives directly or indirectly from an AF node a request for handling an MBS session. The request for handling the MBS session is directed toward release of the MBS session and may be used for removing service requirement and de-allocating TMGI.

Step 1720: the MB-SMF node generates a request for managing MBS broadcast contexts at one or more AMF nodes involved in the MBS session.

Step 1730: the MB-SMF node sends the request to the AMF nodes.

Step 1740: the MB-SMF node receives from the AMF nodes a response on status for the MBS broadcast contexts.

Step 1750: the MB-SMF node sends to the AF node a message on status for the MBS session.

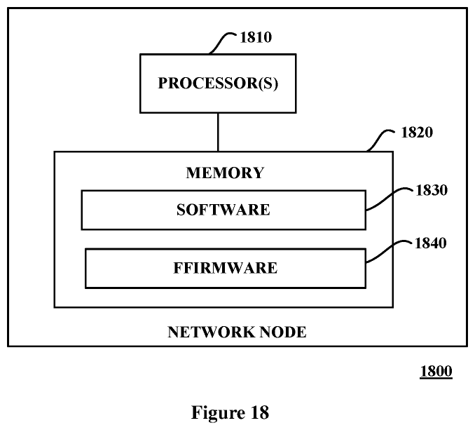

FIG. 18 illustrates a processor-based implementation of a network node which may be used for implementing the above-described embodiments. For example, the structures as illustrated in FIG. 18 may be used for implementing the concepts in the above-mentioned AF node.

As illustrated, the node 1800 may include one or more processors 1810 and a memory 1820 coupled to the processor(s) 1810. By way of example, the processor(s) 1810 and the memory 1820 could be coupled by one or more internal bus systems of the node 1800. The memory 1820 may include a Read-Only-Memory (ROM), e.g., a flash ROM, a Random Access the memory 1820 may include software 1830 and/or firmware 1840. The memory 1820 may include suitably configured program code to be executed by the processor(s) 1810 so as to implement the above-described functionalities, such as explained in connection with FIGS. 1-6 and 15-17.

According to some embodiments, also a computer program may be provided for implementing functionalities of the node 1800, e.g., in the form of a physical medium storing the program code and/or other data to be stored in the memory 1820 or by making the program code available for download or by streaming.

### For Multicast Communication

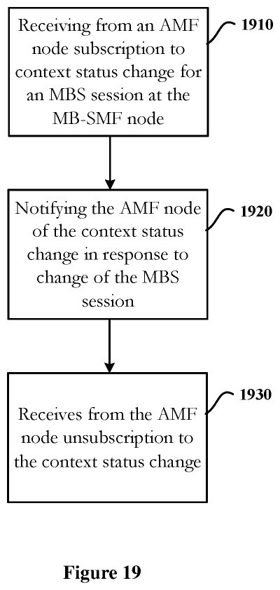

FIG. 19 depicts a flowchart illustrating a method for providing Multicast and Broadcast Service (MBS) according to another embodiment of the present disclosure.

As shown in FIG. 19, the flowchart comprises the following steps:

Step 1910: an MB-SMF node receives from an AMF node subscription to context status change for an MBS session at the MB-SMF node.

Optionally, the subscription to context status change is implicitly made by sending to the MB-SMF node Radio Access Network (RAN) MBS UP information from an RAN involved in the MBS session by the AMF node.

Optionally, the subscription to context status change is explicitly made by sending to the MB-SMF node a request for subscribing to context status change by the AMF node.

Step 1920: in response to change of the MBS session triggered by an Application Function (AF) node, the MB-STF node notifies the AMF node of the context status change.

Step 1930: the MB-SMF node receives from the AMF node unsubscription to the context status change.

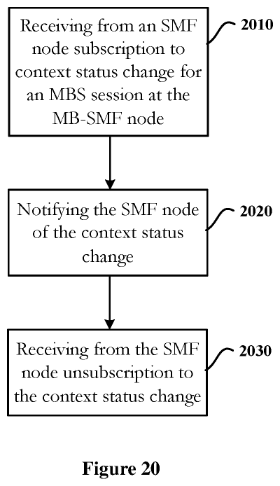

FIG. 20 depicts a flowchart illustrating a method for providing Multicast and Broadcast Service (MBS) according to another embodiment of the present disclosure.

As shown in FIG. 20, the flowchart comprises the following steps:

Step 2010: an MB-SMF node receives from an SMF node subscription to context status change for an MBS session at the MB-SMF node.

Optionally, the MB-SMF node receives from the SMF node Downlink (DL) tunnel information for unicast in an update context service operation, wherein subscription to context status change for an MBS session at the MB-SMF node is implicitly made by sending the DL tunnel information.

Optionally, the subscription to context status change includes an indication that current context status for the MBS session shall be reported immediately by the MB-SMF node.

Step 2020: the MB-STF node notifies the SMF node of the context status change.

Step 2030: the MB-SMF node receives from the SMF node unsubscription to the context status change.

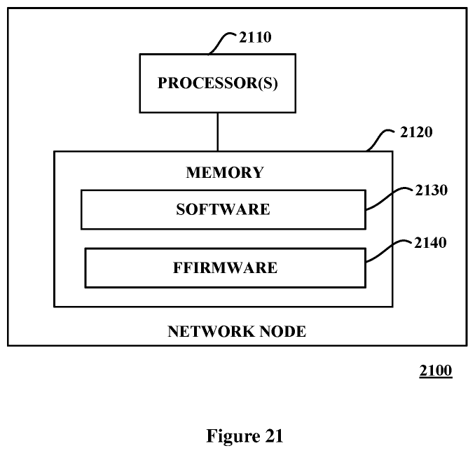

FIG. 21 illustrates a processor-based implementation of a network node which may be used for implementing the above-described embodiments. For example, the structures as illustrated in FIG. 21 may be used for implementing the concepts in the above-mentioned AF node.

As illustrated, the node 2100 may include one or more processors 2110 and a memory 2120 coupled to the processor(s) 2110. By way of example, the processor(s) 2110 and the memory 2120 could be coupled by one or more internal bus systems of the node 2100. The memory 2120 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 2120 may include software 2130 and/or firmware 2140. The memory 2120 may include suitably configured program code to be executed by the processor(s) 2110 so as to implement the above-described functionalities, such as explained in connection with FIGS. 1-6 and 20.

According to some embodiments, also a computer program may be provided for implementing functionalities of the node 2100, e.g., in the form of a physical medium storing the program code and/or other data to be stored in the memory 2120 or by making the program code available for download or by streaming.

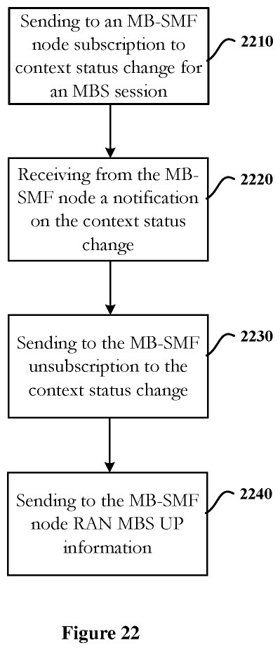

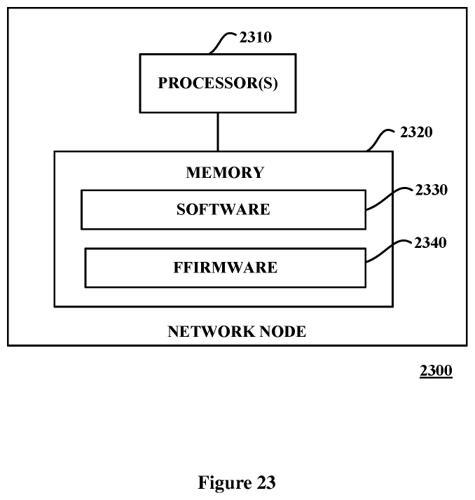

FIG. 22 depicts a flowchart illustrating a method for providing Multicast and Broadcast Service (MBS) according to another embodiment of the present disclosure.

As shown in FIG. 22, the flowchart comprises the following steps:

Step 2210: an AMF node sends to an MB-SMF node subscription to context status change for an MBS session at the MB-SMF node.

Optionally, at step 2210, the subscription to context status change is explicitly made by sending to the MB-SMF node a request for subscribing to context status change by the AMF node.

Optionally, at step 2210, the subscription to context status change is implicitly made by sending the RAN MBS UP information.

Step 2220: the AMF node receives from the MB-SMF node a notification on the context status change.

Step 2230: the AMF node sends to the MB-SMF unsubscription to the context status change.

Optionally, the flowchart may further comprise the following step:

Step 2240: the AMF node sends to the MB-SMF node Radio Access Network (RAN) MBS UP information from an RAN involved in the MBS session. Note that this step can be carried out independent of other steps in FIG. 22 though it follows step 2230 in FIG. 22.

FIG. 23 illustrates a processor-based implementation of a network node which may be used for implementing the above-described embodiments. For example, the structures as illustrated in FIG. 23 may be used for implementing the concepts in the above-mentioned AF node.

As illustrated, the node 2300 may include one or more processors 2310 and a memory 2320 coupled to the processor(s) 2310. By way of example, the processor(s) 2310 and the memory 2320 could be coupled by one or more internal bus systems of the node 2300. The memory 2320 may include a Read-Only-Memory (ROM), e.g., a flash ROM, a Random Access the memory 2320 may include software 2330 and/or firmware 2340. The memory 2320 may include suitably configured program code to be executed by the processor(s) 2310 so as to implement the above-described functionalities, such as explained in connection with FIGS. 1-6 and 22.

According to some embodiments, also a computer program may be provided for implementing functionalities of the node 2300, e.g., in the form of a physical medium storing the program code and/or other data to be stored in the memory 2320 or by making the program code available for download or by streaming.

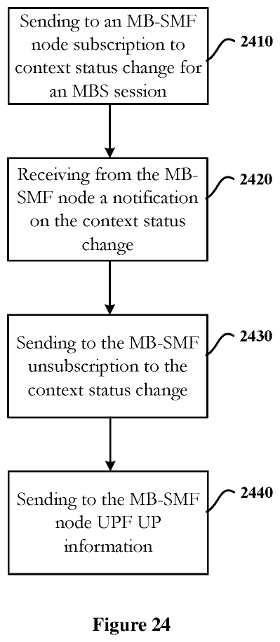

FIG. 24 depicts a flowchart illustrating a method for providing Multicast and Broadcast Service (MBS) according to another embodiment of the present disclosure.

As shown in FIG. 24, the flowchart comprises the following steps:

Step 2410: an SMF node sends to an MB-SMF node subscription to context status change for an MBS session at the MB-SMF node.

Optionally, the SMF node sends, to the MB-SMF node, Downlink (DL) tunnel information for unicast in an update context service operation, wherein subscription to context status change for an MBS session at the MB-SMF node is implicitly made by sending the DL tunnel information.

Optionally, the subscription to context status change includes an indication that current context status for the MBS session shall be reported immediately by the MB-SMF node.

Step 2420: the SMF node receives from the MB-SMF node a notification on the context status change.

Step 2430: the AMF node sends to the MB-SMF unsubscription to the context status change.

Optionally, the flowchart may further comprise the following step:

Step 2440: the AMF node sends to the MB-SMF node UPF UP information. Note that this step can be carried out independent of other steps in FIG. 24 though it follows step 2430 in FIG. 24.

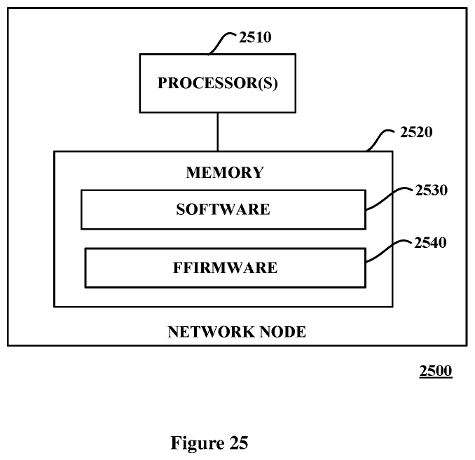

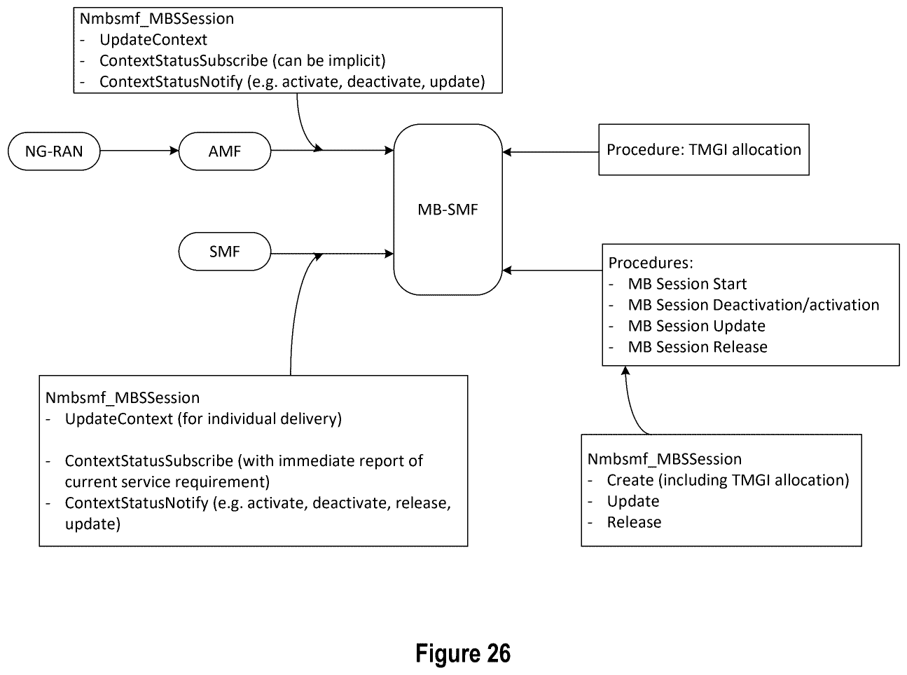

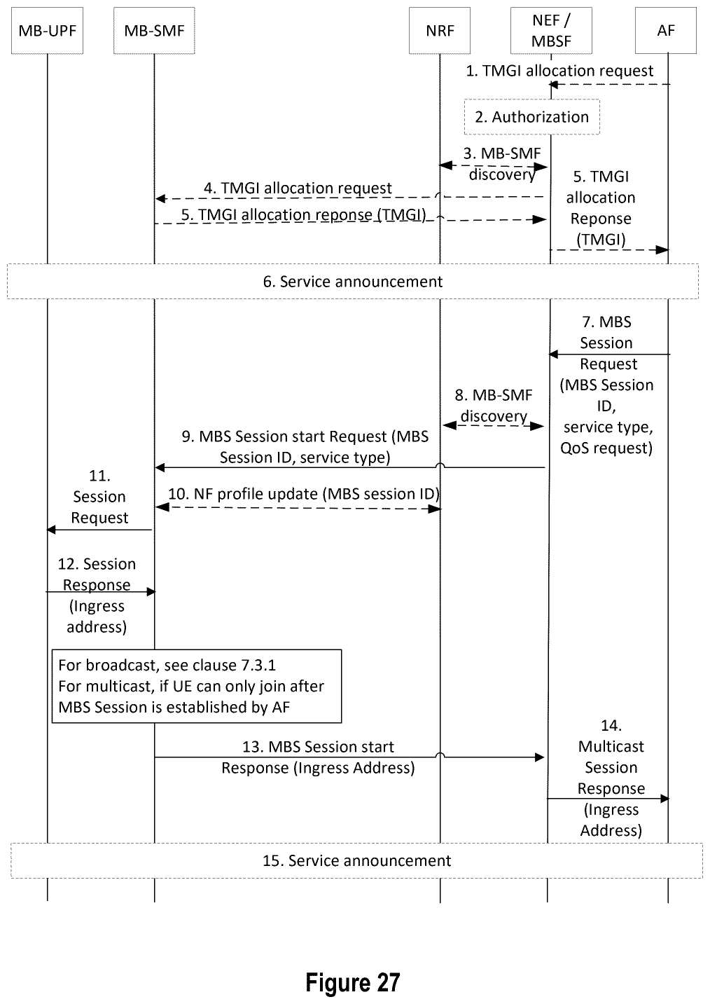

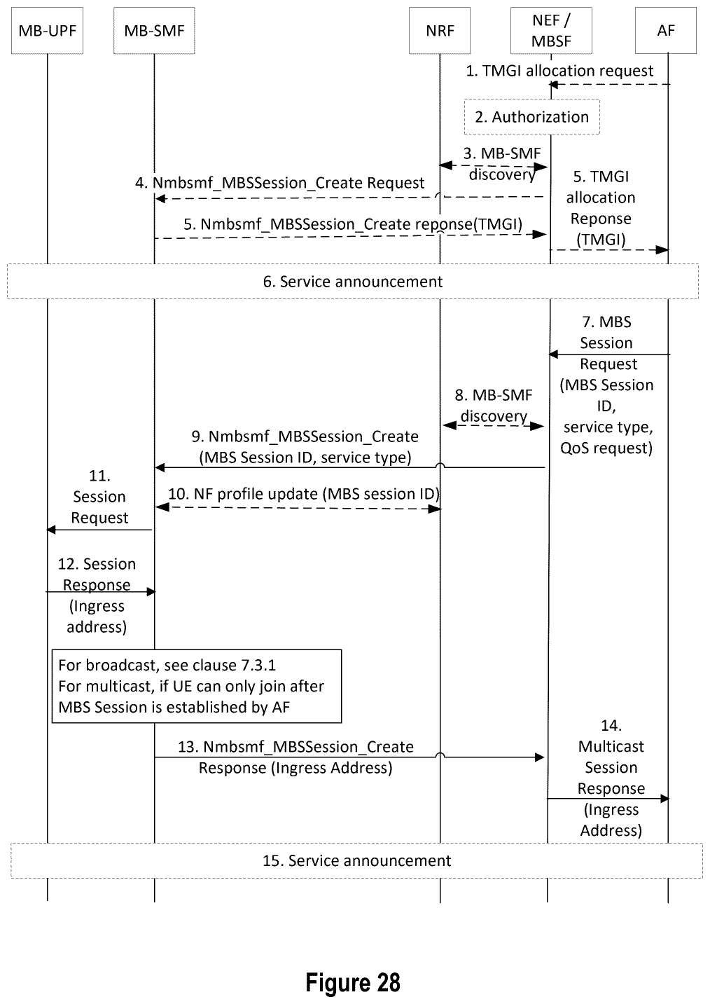

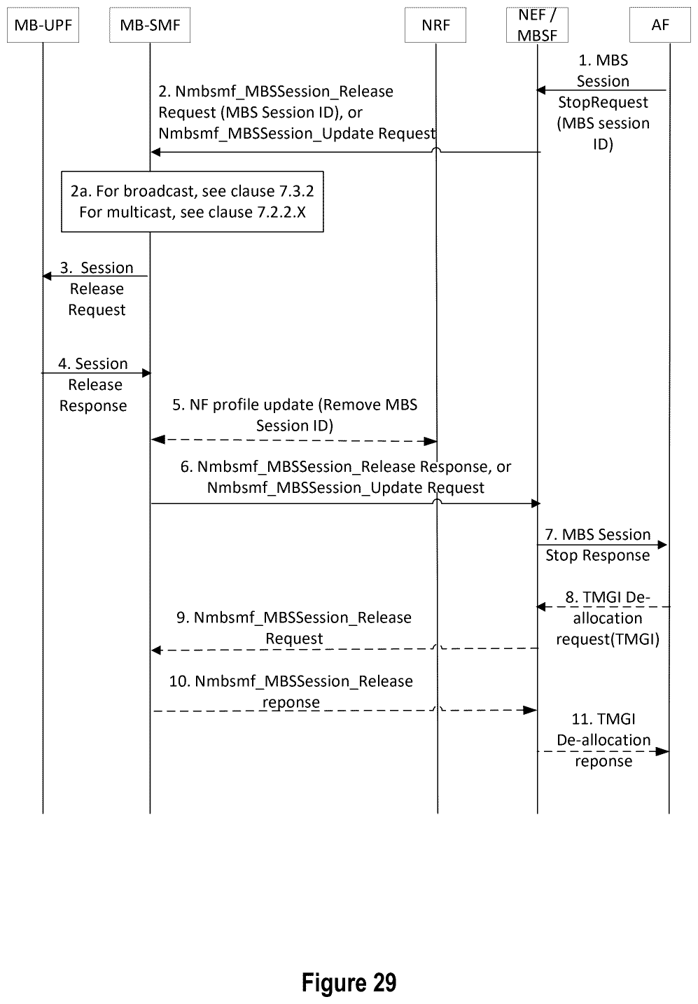

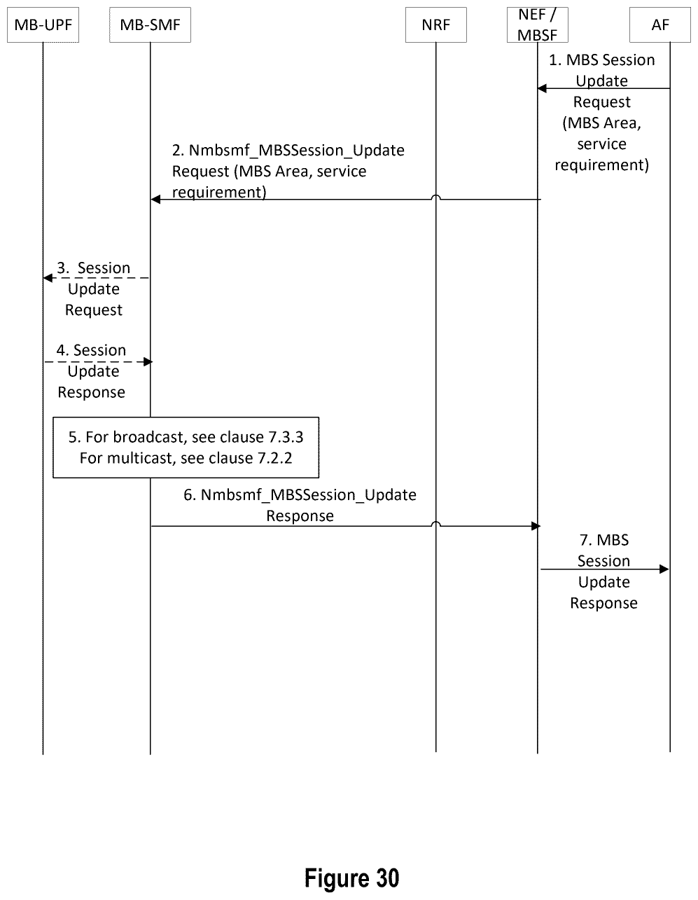

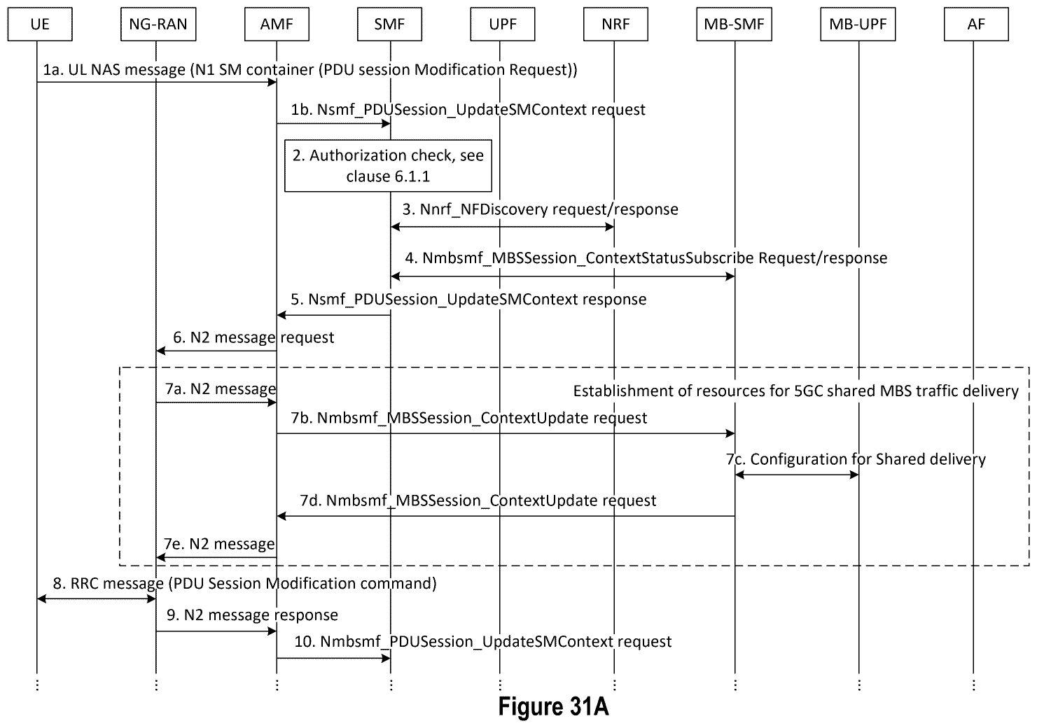

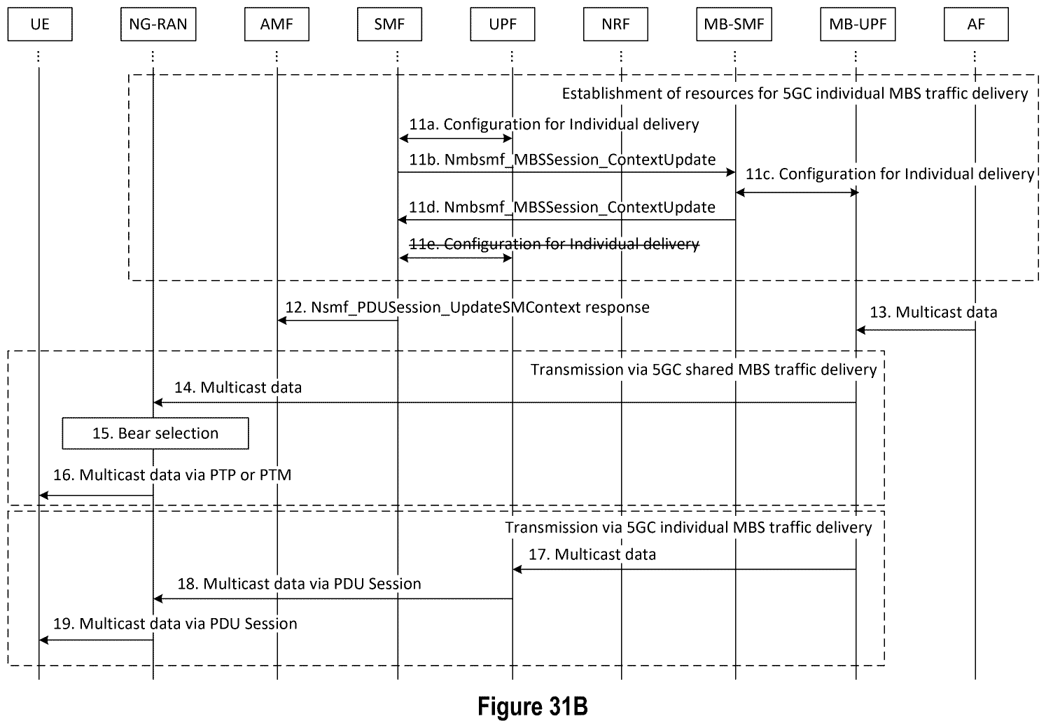

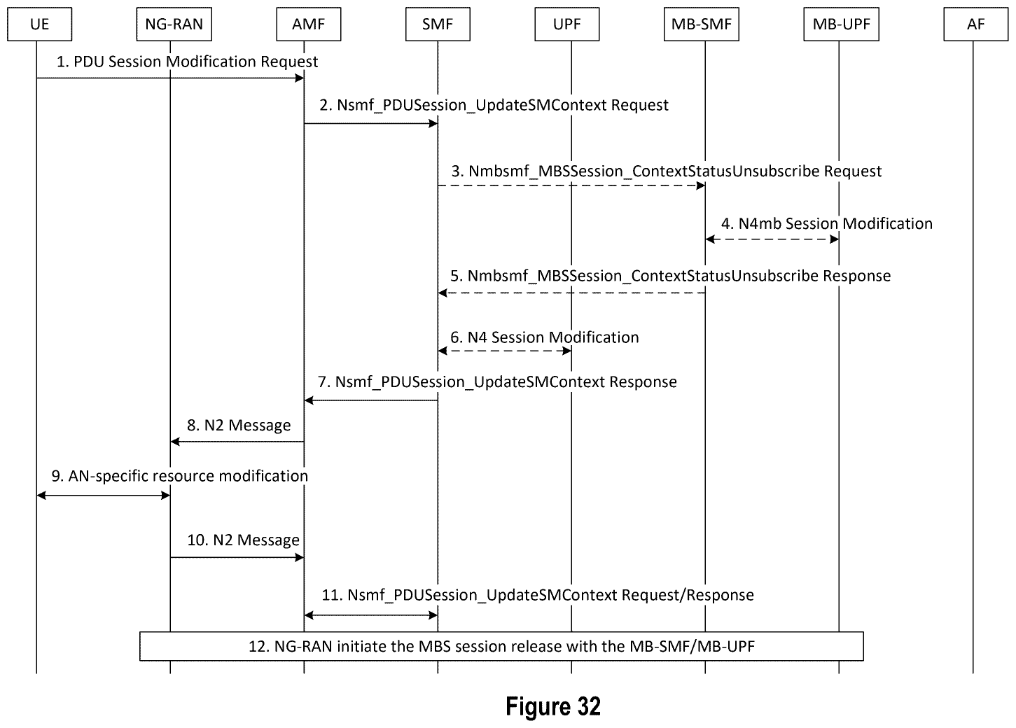

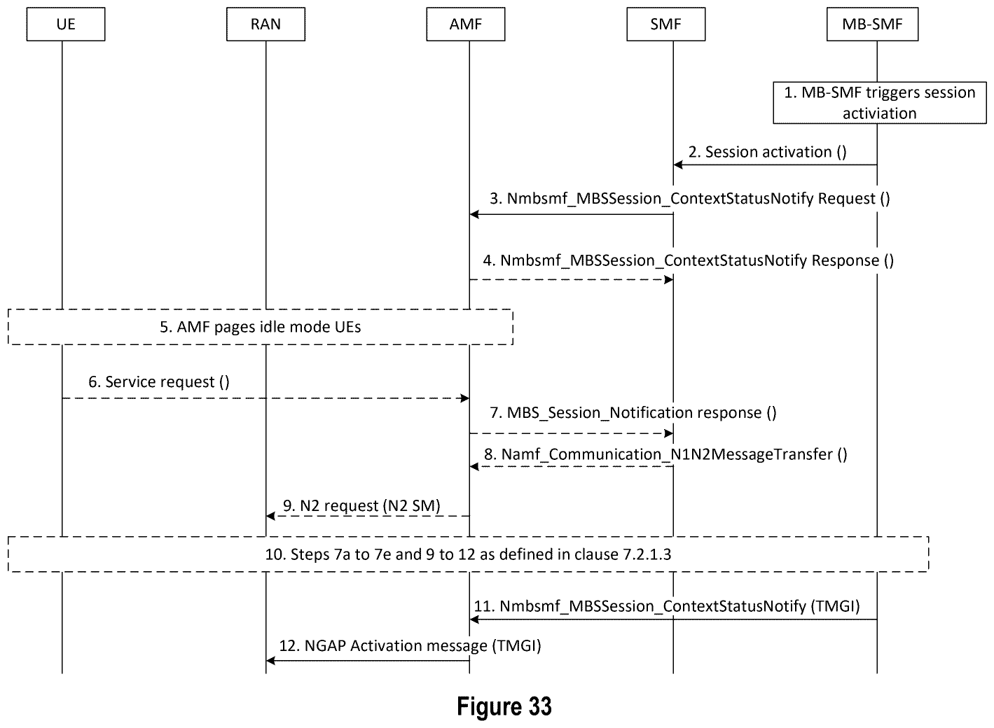

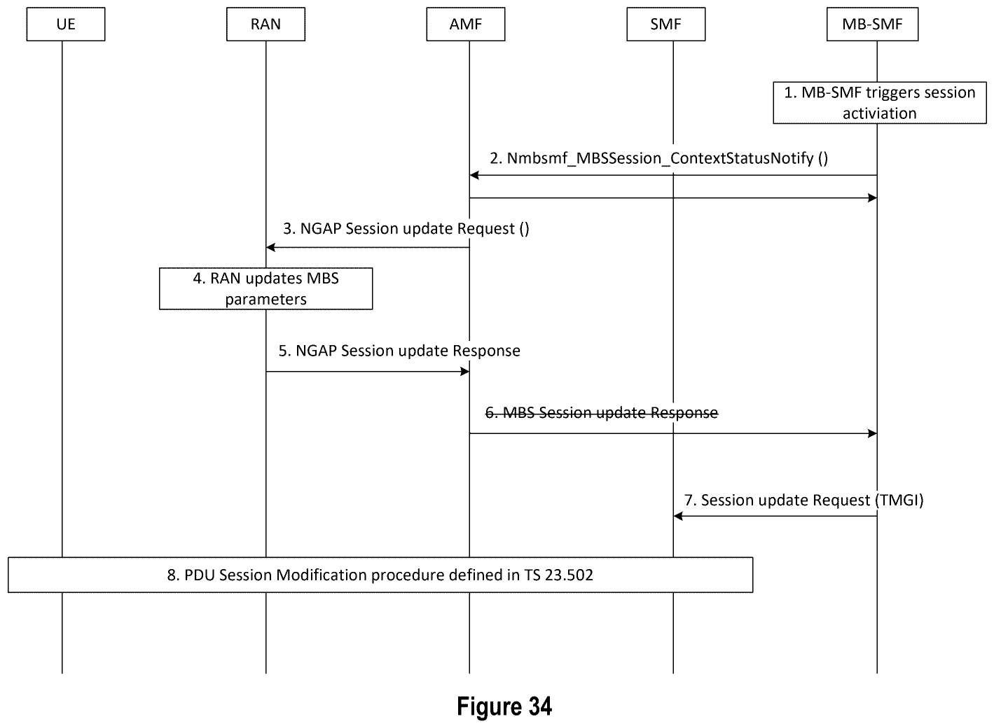

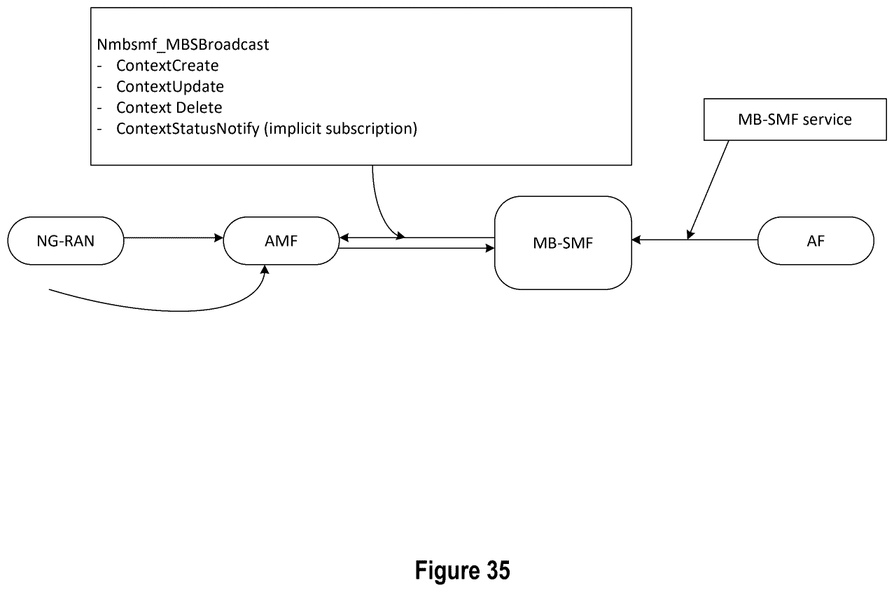

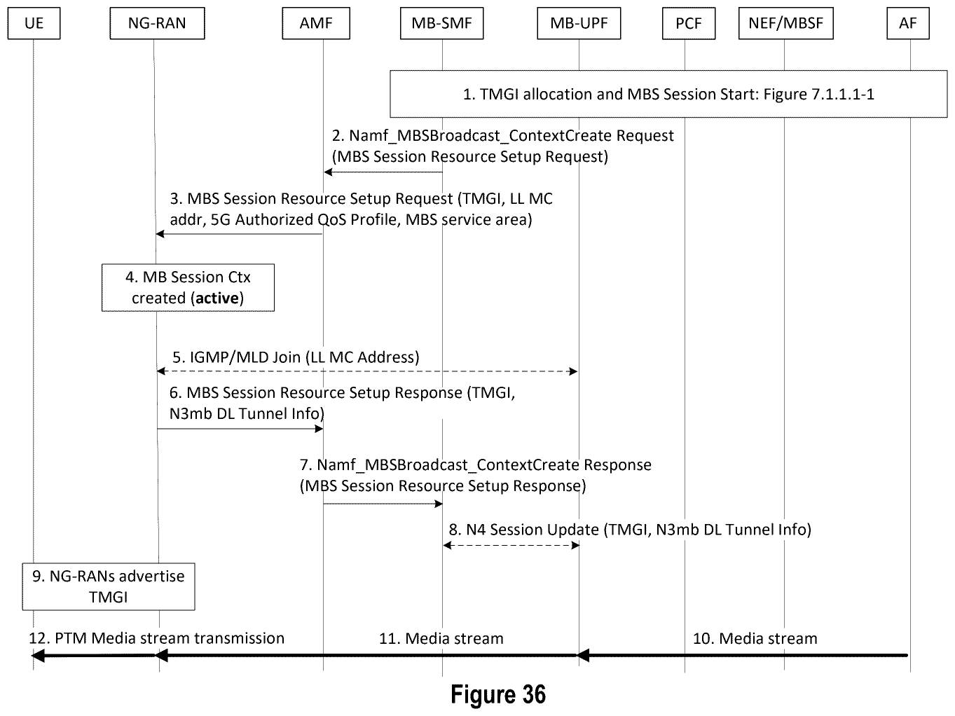

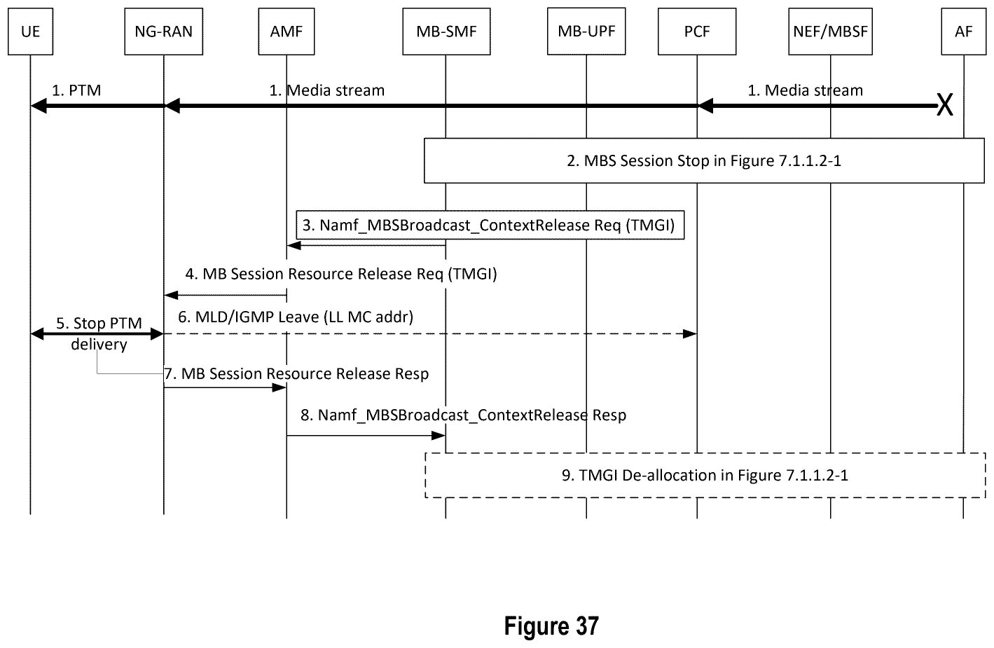

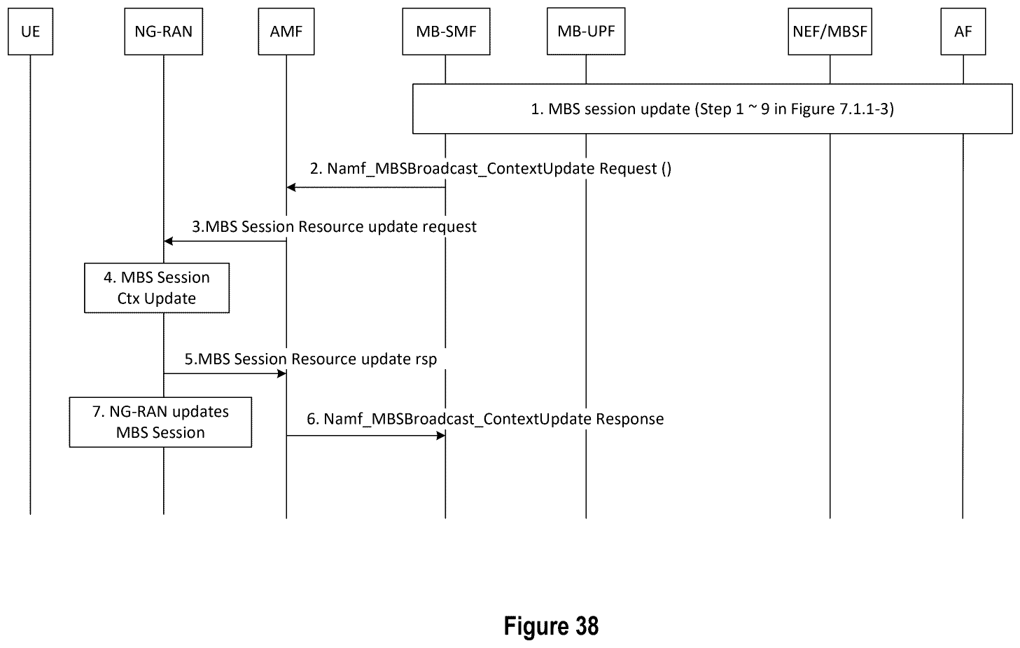

FIG. 25 illustrates a processor-based implementation of a network node which may be used for implementing the above-described embodiments. For example, the structures as illustrated in FIG. 25 may be used for implementing the concepts in the above-mentioned AF node.

As illustrated, the node 2500 may include one or more processors 2510 and a memory 2520 coupled to the processor(s) 2510. By way of example, the processor(s) 2510 and the memory 2520 could be coupled by one or more internal bus systems of the node 2500. The memory 2520 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 2520 may include software 2530 and/or firmware 2540. The memory 2520 may include suitably configured program code to be executed by the processor(s) 2510 so as to implement the above-described functionalities, such as explained in connection with FIGS. 1-6 and 24.

According to some embodiments, also a computer program may be provided for implementing functionalities of the node 2500, e.g., in the form of a physical medium storing the program code and/or other data to be stored in the memory 2520 or by making the program code available for download or by streaming.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the scope of the disclosure as those skilled in the art readily understand. Such modifications and variations are considered to be within the scope of the disclosure and the appended claims. The protection scope of the disclosure is defined by the accompanying claims.

1.-51. (canceled)

52. A method for providing Multicast and Broadcast Service (MBS), the method comprising:
at a Multicast and Broadcast-Session Management Function (MB-SMF) node, generating a request for managing MBS broadcast contexts at one or more Access and Mobility Management Function (AMF) nodes involved in an MBS session; and
sending the request from the MB-SMF node to the one or more AMF nodes.

53. The method of claim 52, further comprising, at the MB-SMF node, receiving directly or indirectly from a network function node a request for handling the MBS session, wherein the network function node is one of an Application Function (AF) node, a Network Exposure Function (NEF) node, and a Multicast Broadcast Service Function (MBSF) node, wherein the request for handling the MBS session is:
directed toward creation of the MBS session and used for obtaining a Temporary Mobile Group Identifier (TMGI) only, obtaining a TMGI and providing a service requirement, or providing a service requirement; or
directed toward updating of the MBS session and used for providing a service requirement, updating a service requirement and/or an MBS service area, or removing a service requirement; or
directed toward release of the MBS session and used for removing a service requirement and de-allocating a Temporary Mobile Group Identifier (TMGI).

54. The method of claim 52, further comprising:
at the MB-SMF node, receiving, from an Access and Mobility Management Function (AMF) node or from a Session Management Function (SMF) node, subscription to context status change for the MBS session at the MB-SMF node; and
at the MB-SMF node, notifying the AMF node or the SMF node of the context status change.

55. The method of claim 54, wherein said notifying comprises notifying the AMF node in response to change of the MBS session triggered by an Application Function (AF) node, wherein the method further comprises, at the MB-SMF node, receiving, from the AMF node, Radio Access Network (RAN) User Plane (UP) information from an RAN involved in the MBS session, wherein subscription to context status change is implicitly made by sending the RAN UP information.

56. The method of claim 54, wherein said notifying comprises notifying the SMF node, and wherein the method further comprises, at the MB-SMF node, receiving, from the SMF node, Downlink (DL) tunnel information for unicast in an update context service operation, wherein subscription to context status change for the MBS session at the MB-SMF node is implicitly made by sending the DL tunnel information.

57. The method according to claim 52, further comprising, at the MB-SMF node, receiving from the one or more AMF nodes a response on a status for the MBS broadcast contexts.

58. The method according to claim 57, wherein generating the request for managing MBS broadcast contexts comprises:
in response to an event that the MBS session is created by an Application Function (AF) node, generating a request for creating the MBS broadcast contexts as the request for managing the MBS broadcast contexts, wherein the request for creating the MBS broadcast contexts includes at least one of: a Temporary Mobile Group Identifier (TMGI), an MBS quality of service (QOS) profile, a broadcast service area, or an MBS Internet Protocol (IP) multicast distribution; or
in response to an event that the MBS Session is updated by an Application Function (AF) node, generating a request for updating the MBS broadcast contexts as the request for managing MBS broadcast contexts, wherein the request for updating the MBS broadcast contexts includes at least one of: a TMGI, an MBS QoS profile, or a broadcast service area; or
in response to an event that the MBS session is released by an Application Function (AF) node, generating a request for releasing the MBS broadcast contexts as the request for managing the MBS broadcast contexts, wherein the request for releasing the MBS broadcast contexts includes a Temporary Mobile Group Identifier (TMGI).

59. The method according to claim 58, further comprising, at the MB-SMF node, sending to the AF node a message on a status for the MBS session based on the response on a status for the MBS broadcast contexts.

60. The method according to claim 57, wherein generating the request for managing MBS broadcast contexts comprises:
in response to an event that the MBS session is updated by an Application Function (AF) node, if it is determined that there is any new AMF node involved in the MBS session, generating a request for creating the MBS broadcast contexts at the new AMF node as the request for managing the MBS broadcast contexts, wherein the request for creating the MBS broadcast contexts includes at least one of an TMGI, an MBS quality of service (QOS) profile, a broadcast service area, or an MBS Internet Protocol (IP) multicast distribution; or
in response to an event that the MBS Session is updated by an Application Function (AF) node, if it is determined that any of the one or more AMF nodes is not involved in the MBS session, generating a request for releasing the MBS broadcast contexts at the AMF node not involved in the MBS session as the request for managing MBS broadcast contexts, wherein the request for releasing the MBS broadcast contexts includes a TMGI.

61. The method according to claim 57, wherein the response on a status for the MBS broadcast contexts includes a TMGI or Radio Access Network (RAN) MBS UP information.

62. A method for providing Multicast and Broadcast Service (MBS), the method comprising:
at an Access and Mobility Management Function (AMF) node involved in an MBS session, receiving from a Multicast and Broadcast-Session Management Function (MB-SMF) node a request for managing MBS broadcast contexts at the AMF node;
sending from the AMF node a request for managing an MBS session resource to one or more Radio Access Networks (RANs);
at the AMF node, receiving from the one or more RANs one or more responses on a status for the MBS session resource; and
at the AMF node, sending to the MB-SMF a response on the status for the MBS broadcast contexts based on the one or more responses on the status for the MBS session resource.

63. The method according to claim 62, wherein each of the one or more responses on a status for the MBS session resource includes a TMGI or Radio Access Network (RAN) MBS UP information from the respective RAN.

64. The method of claim 62, further comprising:
at the AMF node, sending to the MB-SMF node subscription to context status change for an MBS session at the MB-SMF node; and
at the AMF node, receiving from the MB-SMF node a notification on the context status change.

65. The method of claim 64, further comprising, at the AMF node, sending to the MB-SMF node Radio Access Network (RAN) User Plane (UP) information from an RAN involved in the MBS session, wherein subscription to context status change is implicitly made by sending the RAN UP information.

66. The method of claim 65, wherein the RAN UP information is RAN node radio User Plane (UL) information in an update context service operation.

67. The method of claim 64, wherein the subscription to context status change is explicitly made by sending to the MB-SMF node a request for subscribing to context status change by the AMF node.

68. The method according to claim 64, further comprising, at the AMF node, sending, to the MB-SMF, unsubscription to the context status change.

69. A method for providing Multicast and Broadcast Service (MBS), the method comprising:
at a Session Management Function (SMF) node, sending to a Multicast and Broadcast-Session Management Function (MB-SMF) node subscription to context status change for an MBS session at the MB-SMF node; and
at the SMF node, receiving from the MB-SMF node a notification on the context status change.

70. The method according to claim 69, further comprising, at the SMF node, sending, to the MB-SMF, User Plane Function (UPF) UP information.

71. The method according to claim 69, further comprising, at the SMF node, sending, to the MB-SMF, unsubscription to the context status change.

72. The method according to claim 69, wherein the subscription to context status change includes an indication that current context status for the MBS session shall be reported immediately by the MB-SMF node.

73. The method of claim 69, further comprising, at the SMF node, sending, to the MB-SMF node, Downlink (DL) tunnel information for unicast in an update context service operation, wherein subscription to context status change for an MBS session at the MB-SMF node is implicitly made by sending the DL tunnel information.

74. A network node for Multicast and Broadcast-Session Management Function (MB-SMF), the network node comprising:
at least one processor; and
a memory containing program code executable by the at least one processor, whereby execution of the program code by the at least one processor causes the network node to implement an MB-SMF node and to:
generate a request for managing MBS broadcast contexts at one or more Access and Mobility Management Function (AMF) nodes involved in an MBS session; and
send the request from the MB-SMF node to the one or more AMF nodes.

75. The network node of claim 74, wherein execution of the program code by the at least one processor causes the network node to receive directly or indirectly from a network function node a request for handling the MBS session, wherein the network function node is one of an Application Function (AF) node, a Network Exposure Function (NEF) node, and a Multicast Broadcast Service Function (MBSF) node, wherein the request for handling the MBS session is:
directed toward creation of the MBS session and used for obtaining a Temporary Mobile Group Identifier (TMGI) only, obtaining a TMGI and providing a service requirement, or providing a service requirement; or
directed toward updating of the MBS session and used for providing a service requirement, updating a service requirement and/or an MBS service area, or removing a service requirement; or
directed toward release of the MBS session and used for removing a service requirement and de-allocating a Temporary Mobile Group Identifier (TMGI).

76. The network node of claim 74, wherein execution of the program code by the at least one processor causes the network node to:
receive, from an Access and Mobility Management Function (AMF) node or from a Session Management Function (SMF) node, subscription to context status change for the MBS session at the MB-SMF node; and
notify the AMF node or the SMF node of the context status change.

77. The network node of claim 76, wherein execution of the program code by the at least one processor causes the network node to notify the AMF node in response to change of the MBS session triggered by an Application Function (AF) node, and to receive, from the AMF node, Radio Access Network (RAN) User Plane (UP) information from an RAN involved in the MBS session, wherein subscription to context status change is implicitly made by sending the RAN UP information.

78. The network node of claim 76, wherein execution of the program code by the at least one processor causes the network node to notify the SMF node and to receive, from the SMF node, Downlink (DL) tunnel information for unicast in an update context service operation, wherein subscription to context status change for the MBS session at the MB-SMF node is implicitly made by sending the DL tunnel information.

79. The network node according to claim 74, wherein execution of the program code by the at least one processor causes the network node to receive from the one or more AMF nodes a response on a status for the MBS broadcast contexts.

80. The network node according to claim 79, wherein execution of the program code by the at least one processor causes the network node to:
in response to an event that the MBS session is created by an Application Function (AF) node, generate a request for creating the MBS broadcast contexts as the request for managing the MBS broadcast contexts, wherein the request for creating the MBS broadcast contexts includes at least one of: a Temporary Mobile Group Identifier (TMGI), an MBS quality of service (QOS) profile, a broadcast service area, or an MBS Internet Protocol (IP) multicast distribution; or
in response to an event that the MBS Session is updated by an Application Function (AF) node, generate a request for updating the MBS broadcast contexts as the request for managing MBS broadcast contexts, wherein the request for updating the MBS broadcast contexts includes at least one of: a TMGI, an MBS QoS profile, or a broadcast service area; or
in response to an event that the MBS session is released by an Application Function (AF) node, generate a request for releasing the MBS broadcast contexts as the request for managing the MBS broadcast contexts, wherein the request for releasing the MBS broadcast contexts includes a Temporary Mobile Group Identifier (TMGI).

81. The network node according to claim 80, wherein execution of the program code by the at least one processor causes the network node to send to the AF node a message on a status for the MBS session based on the response on a status for the MBS broadcast contexts.

82. The network node according to claim 79, wherein execution of the program code by the at least one processor causes the network node to:
in response to an event that the MBS session is updated by an Application Function (AF) node, if it is determined that there is any new AMF node involved in the MBS session, generate a request for creating the MBS broadcast contexts at the new AMF node as the request for managing the MBS broadcast contexts, wherein the request for creating the MBS broadcast contexts includes at least one of an TMGI, an MBS quality of service (QOS) profile, a broadcast service area, or an MBS Internet Protocol (IP) multicast distribution; or
in response to an event that the MBS Session is updated by an Application Function (AF) node, if it is determined that any of the one or more AMF nodes is not involved in the MBS session, generate a request for releasing the MBS broadcast contexts at the AMF node not involved in the MBS session as the request for managing MBS broadcast contexts, wherein the request for releasing the MBS broadcast contexts includes a TMGI.

83. The network node according to claim 79, wherein the response on a status for the MBS broadcast contexts includes a TMGI or Radio Access Network (RAN) MBS UP information.

84. A network node for an Access and Mobility Management Function (AMF), the network node comprising:
at least one processor; and
a memory containing program code executable by the at least one processor, whereby execution of the program code by the at least one processor causes the network node to implement an AMF node involved in an MBS session and to:
receive from a Multicast and Broadcast-Session Management Function (MB-SMF) node a request for managing MBS broadcast contexts at the AMF node;
sending from the AMF node a request for managing an MBS session resource to one or more Radio Access Networks (RANs);
receive from the one or more RANs one or more responses on a status for the MBS session resource; and
send to the MB-SMF a response on the status for the MBS broadcast contexts based on the one or more responses on the status for the MBS session resource.

85. The network node according to claim 84, wherein each of the one or more responses on a status for the MBS session resource includes a TMGI or Radio Access Network (RAN) MBS UP information from the respective RAN.

86. The network node of claim 84, wherein execution of the program code by the at least one processor causes the network node to:
send to the MB-SMF node subscription to context status change for an MBS session at the MB-SMF node; and
receive from the MB-SMF node a notification on the context status change.

87. The network node of claim 86, wherein execution of the program code by the at least one processor causes the network node to send to the MB-SMF node Radio Access Network (RAN) User Plane (UP) information from an RAN involved in the MBS session, wherein subscription to context status change is implicitly made by sending the RAN UP information.

88. The network node of claim 87, wherein the RAN UP information is RAN node radio User Plane (UL) information in an update context service operation.

89. The network node of claim 86, wherein the subscription to context status change is explicitly made by sending to the MB-SMF node a request for subscribing to context status change by the AMF node.

90. The network node according to claim 86, wherein execution of the program code by the at least one processor causes the network node to send, to the MB-SMF, unsubscription to the context status change.

91. A network node for a Session Management Function (SMF), the network node comprising:
at least one processor; and
a memory containing program code executable by the at least one processor, whereby execution of the program code by the at least one processor causes the network node to implement an SMF node and to:
send to a Multicast and Broadcast-Session Management Function (MB-SMF) node subscription to context status change for an MBS session at the MB-SMF node; and
receive from the MB-SMF node a notification on the context status change.

92. The network node according to claim 91, wherein execution of the program code by the at least one processor causes the network node to send, to the MB-SMF, User Plane Function (UPF) UP information.

93. The network node according to claim 91, wherein execution of the program code by the at least one processor causes the network node to send, to the MB-SMF, unsubscription to the context status change.

94. The network node according to claim 91, wherein the subscription to context status change includes an indication that current context status for the MBS session shall be reported immediately by the MB-SMF node.

95. The network node of claim 91, wherein execution of the program code by the at least one processor causes the network node to send, to the MB-SMF node, Downlink (DL) tunnel information for unicast in an update context service operation, wherein subscription to context status change for an MBS session at the MB-SMF node is implicitly made by sending the DL tunnel information.

96. A method for managing a Multicast Broadcast Service (MBS) broadcast context in one or more Access and Mobility Management Function (AMF) nodes involved in an MBS session, the method comprising:
at a network function node, sending a request for handling the MBS session to a Multicast and Broadcast-Session Management Function (MB-SMF) node directly or indirectly, wherein the network function node is one of an Application Function (AF) node, a Network Exposure Function (NEF) node, and a Multicast Broadcast Service Function (MBSF) node, wherein the request for handling the MBS session is:
sent in response to creation of the MBS session and used for obtaining a Temporary Mobile Group Identifier (TMGI) only, obtaining a TMGI and providing a service requirement, or providing a service requirement; or
sent in response to updating of the MBS session and used for providing a service requirement, updating a service requirement and/or an MBS service area, or removing a service requirement; or
sent in response to release of the MBS session and used for removing a service requirement and de-allocating a Temporary Mobile Group Identifier (TMGI).
